(19) United States
(12) Patent Application Publication
(10) Pub. No.: US 2022/0286177 A1
(43) Pub. Date: Sep. 8, 2022

(54) METHOD AND APPARATUS FOR REPORTING CHANNEL STATE INFORMATION

(71) Applicant: Samsung Electronics Co., Ltd., Suwon-si (KR)

(72) Inventors: Dalin Zhu, Richardson, TX (US); Md. Saifur Rahman, Plano, TX (US); Eko Onggosanusi, Coppell, TX (US)

(21) Appl. No.: 17/653,606

(22) Filed: Mar. 4, 2022

Related U.S. Application Data
(60) Provisional application No. 63/158,209, filed on Mar. 8, 2021.

(51) Int. Cl. H04B 7/06; H04L 5/00; H04W 24/10

(52) U.S. Cl. CPC H04B 7/0626; H04L 5/0053; H04W 24/10

(57) ABSTRACT

Apparatuses and methods for aperiodic channel state information (CSI) resource configuration, measurement, and reporting in a wireless communication system. A method for operating a user equipment (UE) includes receiving, in a DCI format, a channel state information (CSI) request for one or more entity identities (IDs) and receiving configuration information for an aperiodic CSI (A-CSI) trigger state. The method further includes determining, based on the CSI request, the A-CSI trigger state; determining, based on the determined A-CSI trigger state and the configuration information, one or more CSI resources associated with the one or more entity IDs; and generating one or more CSI reports based on the determined CSI resources. The entity IDs correspond to a physical cell ID (PCI), a CORESETPoolIndex value, a PCI index pointing to a PCI, a reference signal (RS) resource ID, a RS resource set ID, or a RS resource setting ID.

### CROSS-REFERENCE TO RELATED APPLICATIONS AND CLAIM OF PRIORITY

The present application claims priority to U.S. Provisional Patent Application No. 63/158,209, filed on Mar. 8, 2021. The content of the above-identified patent document is incorporated herein by reference.

### TECHNICAL FIELD

The present disclosure relates generally to wireless communication systems and, more specifically, the present disclosure relates to aperiodic channel state information (CSI) resource configuration, measurement, and reporting in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to aperiodic CSI resource configuration, measurement, and reporting in a wireless communication system.

In one embodiment, a user equipment (UE) is provided. The UE includes a transceiver configured to receive a CSI request for one or more entity identities (IDs) and receive configuration information for an aperiodic CSI (A-CSI) trigger state. The UE further includes a processor operably coupled to the transceiver. The processor is configured to determine, based on the CSI request, the A-CSI trigger state; determine, based on the determined A-CSI trigger state and the configuration information, one or more CSI resources associated with the one or more entity IDs; and generate one or more CSI reports based on the determined one or more CSI resources associated with the one or more entity IDs. The one or more entity IDs correspond to at least one of: a physical cell ID (PCI), a CORESETPoolIndex value, a PCI index pointing to a PCI in a list of PCIs that are higher layer configured to the UE, a reference signal (RS) resource ID, a RS resource set ID, and a RS resource setting ID.

In another embodiment, a base station (BS) is provided. The BS includes a processor and a transceiver operably coupled to the processor. The transceiver is configured to transmit a CSI request for one or more entity IDs; transmit configuration information for an A-CSI trigger state; and receive one or more CSI reports based on or more CSI resources associated with the one or more entity IDs. The one or more CSI resources associated with the one or more entity IDs are indicated based on the A-CSI trigger state and the configuration information. The one or more entity IDs correspond to at least one of: a PCI, a CORESETPoolIndex value, a PCI index pointing to a PCI in a list of PCIs that are higher layer configured, a RS resource ID, a RS resource set ID, and a RS resource setting ID.

In yet another embodiment, a method for operating a UE is provided. The method includes receiving a CSI request for one or more entity IDs and receiving configuration information for an A-CSI trigger state. The method further includes determining, based on the CSI request, the A-CSI trigger state; determining, based on the determined A-CSI trigger state and the configuration information, one or more CSI resources associated with the one or more entity IDs; and generating one or more CSI reports based on the determined one or more CSI resources associated with the one or more entity IDs. The one or more entity IDs correspond to at least one of: a PCI, a CORESETPoolIndex value, a PCI index pointing to a PCI in a list of PCIs that are higher layer configured to the UE, a RS resource ID, a RS resource set ID, and a RS resource setting ID.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrate an example of wireless communications system comprising distributed RRHs according to embodiments of the present disclosure;

FIG. 7 illustrate an example of remote radio head (RRH) groups and clusters in a distributed RRH system according to embodiments of the present disclosure;

FIG. 8 illustrates a flowchart of method for A-CSI resource configuration, triggering, measurement and reporting procedure according to embodiments of the present disclosure;

FIG. 9 illustrates an example of associating an A-CSI trigger state, a CSI reporting setting and one or more CSI resources in a CSI resource set for a distributed RRH system according to embodiments of the present disclosure;

FIG. 10 illustrates an example of associating an A-CSI trigger state, one or more CSI reporting settings and one or more CSI resources in a CSI resource set for a distributed RRH system according to embodiments of the present disclosure;

FIG. 11 illustrates an example of associating an A-CSI trigger state, a CSI reporting setting and one or more CSI resource sets in a CSI resource setting for a distributed RRH system according to embodiments of the present disclosure;

FIG. 12 illustrates an example of associating an A-CSI trigger state, one or more CSI reporting settings and one or more CSI resources sets in a CSI resource setting for a distributed RRH system according to embodiments of the present disclosure;

FIG. 13 illustrates an example of associating an A-CSI trigger state, a CSI reporting setting and one or more CSI resource settings for a distributed RRH system according to embodiments of the present disclosure; and

FIG. 14 illustrates an example of associating an A-CSI trigger state, one or more CSI reporting settings and one or more CSI resource settings for a distributed RRH system according to embodiments of the present disclosure.

### DETAILED DESCRIPTION

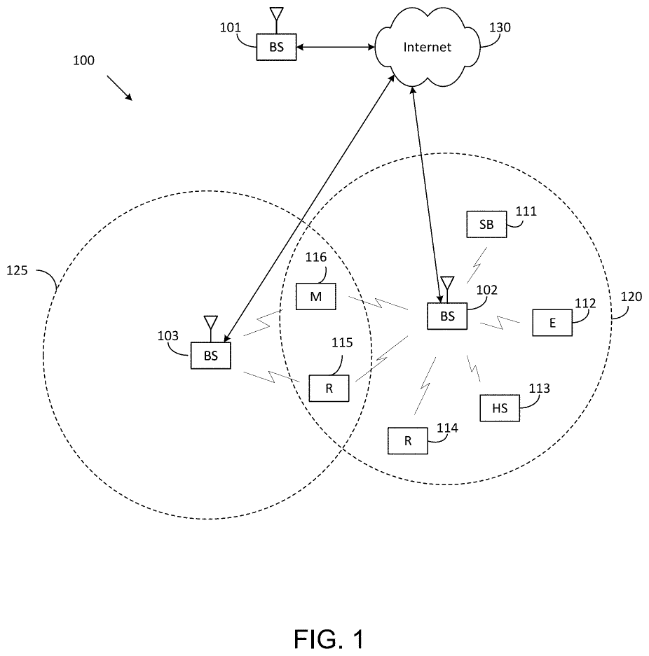

FIG. 1 through FIG. 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for measuring and reporting CSI in a wireless communication system. In certain embodiments, and one or more of the gNBs 101-103 includes circuitry, programing, or a combination thereof, for measuring and reporting CSI in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

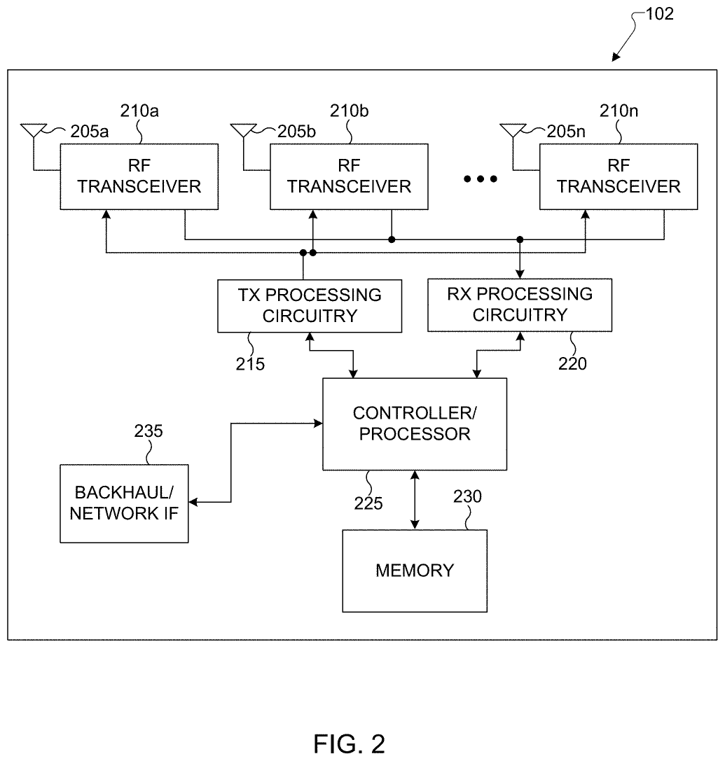

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of downlink (DL) channel signals and the transmission of uplink (UL) channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support measuring and reporting CSI in a wireless communication system. Another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

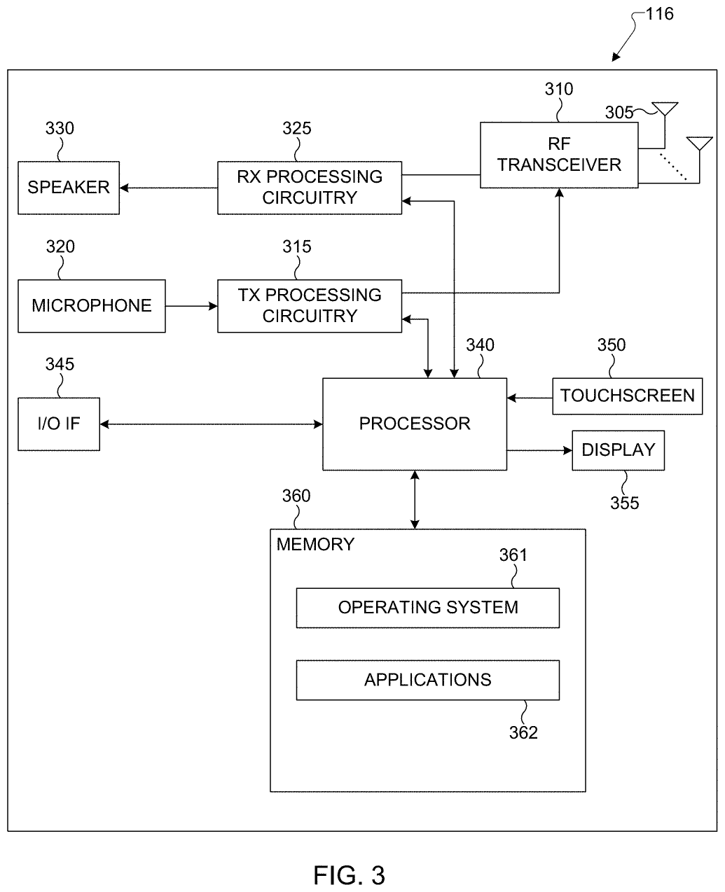

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for measuring and reporting CSI in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 15 KHz or 30 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

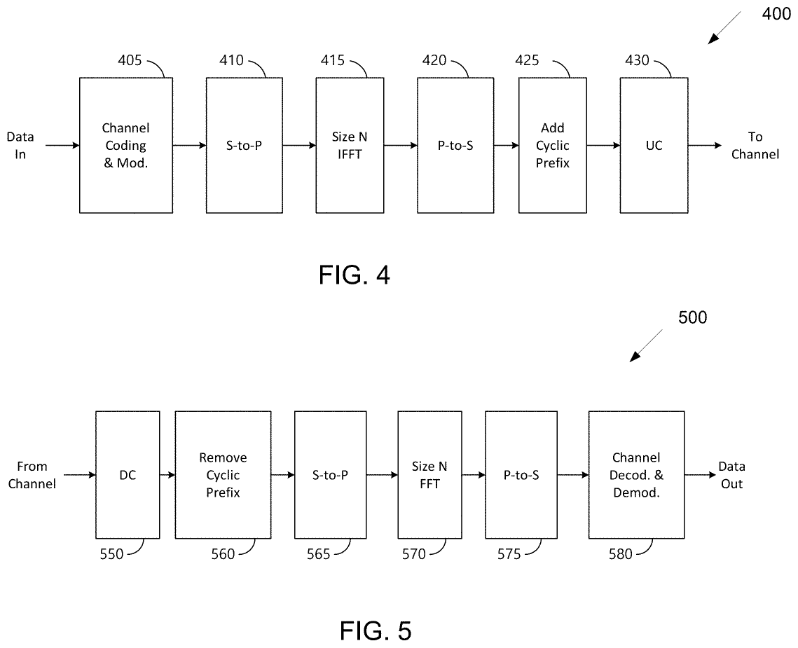

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In a wireless communications system, a UE could communicate with a large number of remote radio heads (RRHs), distributed within a certain area. Each RRH could be equipped with an antenna array having a certain number of antenna elements/ports. The 5G NR supports up to 32 CSI-RS antenna ports, which can be distributed among the RRHs. One or more RRHs could be connected through a single baseband processing unit such that signals transmitted from or received at different RRHs could be processed in a centralized manner.

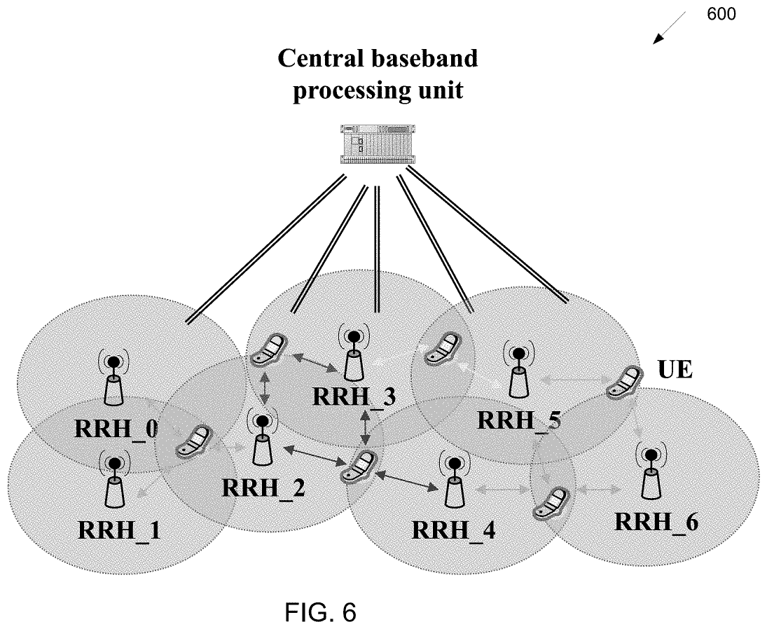

FIG. 6 illustrate an example of wireless communications system comprising distributed RRHs 600 according to embodiments of the present disclosure. An embodiment of the wireless communications system comprising distributed RRHs 600 shown in FIG. 6 is for illustration only.

A wireless communications system comprising of 7 distributed RRHs is depicted in FIG. 6. As can be seen from FIG. 6, the seven distributed RRHs are connected through a central baseband processing unit. Further, a UE could communicate with multiple RRHs in both downlink and uplink directions. For instance, the UE on the far right in FIG. 6 could transmit/receive to/from RRH_5 and RRH_6. Here, RRH_5 and RRH_6 could be regarded as a RRH cluster for the UE. Each RRH cluster could correspond to one or more transmit/receive (TX/RX) entities such as antenna ports, antenna panels, transmission-reception points (TRPs) and/or etc.

For another example, the UE on the far left in FIG. 6 could transmit/receive to/from three RRHs, RRH_0, RRH_1 and RRH_2, in both downlink and uplink directions, and RRH_0, RRH_1 and RRH_2 could be regarded as the RRH cluster for this UE. The 32 CSI-RS ports can be distributed across RRH_5 and RRH_6 for the UE on the far right, each with 16 antenna ports.

For the distributed RRH system wherein a UE could communicate with multiple geographically separated RRHs, aperiodic CSI (A-CSI) triggering, measurement and reporting mechanisms need to be specified for various combinations of CSI resource/report settings. Further, enhancements on the CSI report setting (e.g., the CSI reporting format) for the distributed RRH system are needed. The enhancements could target for different system configurations such as deployment of non-ideal backhaul.

The present disclosure provides several design issues for the distributed RRH system, wherein a UE could communicate with multiple RRHs in both DL and UL directions. Detailed A-CSI triggering (e.g., trigger state), measurement and reporting mechanisms are specified for the distributed RRH system. Further, a hybrid of group based and non-group based CSI reporting format is developed accounting for various system settings such as non-ideal backhaul between RRHs. The corresponding network/UE configuration/indication methods are also discussed in this disclosure.

In the following description, an RRH can represent a collection of measurement antenna ports or measurement RS resources. For example, an RRH can be associated with a plurality of CSI-RS resources or CRIs (CSI-RS resource indices/indicators). Optionally, an RRH can be associated with a measurement RS resource set—or, for example, CSI resource set along with its indicator.

The term “RRH cluster” can represent a cluster of RRHs and, hence, a cluster of collections of measurement RS resources or a cluster of measurement RS resource sets.

Throughout the present disclosure, a CSI-RS resource set is equivalent to a CSI resource set or vice versa. For instance, a CSI-RS resource set or a CSI resource set could correspond to a SSB resource set provided by a higher layer parameter CSI-SSB-ResourceSet or a non-zero-power (NZP) CSI-RS resource set provided by a higher layer parameter nzp-CSI-RS-ResourceSet.

Furthermore, throughout the present disclosure, a CSI-RS resource is equivalent to a CSI resource or vice versa. For instance, a CSI-RS resource or a CSI resource could correspond to a SSB resource or a NZP CSI-RS resource.

In addition, throughout the present disclosure, a CSI report setting is equivalent to a CSI reporting setting or a CSI reporting configuration, and a CSI resource setting is equivalent to a CSI resource configuration. For instance, a CSI report setting or a CSI reporting setting or a CSI reporting configuration could be provided by a higher layer parameter CSI-ReportConfig, and a CSI resource setting or a CSI resource configuration could be provided by a higher layer parameter CSI-ResourceConfig.

There are various means to configure a RRH cluster for a given UE in a distributed RRH system.

In one example of Option-1 (NW determines RRH clustering), the UE could be configured by the network to measure one or more reference signals (RSs) for RRH clustering from one or more RRHs. The UE could then report to the network the corresponding measurement results (i.e., as a CSI report), upon which the network could determine the RRH cluster for the UE of interest. The measurement results could be based on a metric such as L1-RSRP, L1-SINR and/or other L1 metrics, and can include at least one metric value or/and a corresponding RS index. The UE could then be configured/indicated by the network the RRH clustering results, which could comprise of the corresponding RRH ID(s)/index/indices, a primary RRH ID/index, and etc. Under certain settings, the RRH clustering results are transparent to the UE, i.e., the RRH clustering results are not indicated to the UE from the network.

In such example, to facilitate measuring the RSs for RRH clustering from different RRHs and reporting the measurement results, the RSs for RRH clustering from different RRHs could be multiplexed in time, frequency, spatial and/or code domains. For instance, the UE could be configured by the network to measure the RSs for RRH clustering from different RRHs in different symbols/slots/etc. For another example, the UE could be configured by the network to measure the RSs for RRH clustering from different RRHs in different resource blocks. The UE could also be indicated by the network the association rule(s)/mapping relationship(s) between the RRH IDs/indices and the RSs for RRH clustering. In this case, the UE could know which RRH(s) the corresponding RSs for RRH clustering are transmitted from.

In such example, to facilitate measuring the RSs for RRH clustering from different RRHs and reporting the measurement results, the UE could be configured by the network to report the measurement results through certain time, frequency, spatial and/or code domain resources. For instance, the UE could be configured by the network to report the measurement results for different RRHs through different symbols/slots/etc. For another example, the UE could be configured by the network to report the measurement results for different RRHs through different resource blocks. The UE could be indicated by the network the association rule(s)/mapping relationship(s) between the RSs for RRH clustering and the reports and/or between the RRH IDs/indices and the reports. Alternatively, the UE could autonomously determine the association rule(s)/mapping relationship(s) between the RSs for RRH clustering (or the RRH IDs/indices) and the reports, and indicate to the network the association rule(s)/mapping relationship(s).

In one example of Option-2, the UE could autonomously determine its RRH cluster based on the measurement results of the DL RSs for RRH clustering from different RRHs. The UE could indicate to the network the RRH clustering results, which could comprise of the corresponding RRH ID(s)/index/indices, a primary RRH ID/index, and etc. In this case, the UE needs to be indicated by the network the association rule(s)/mapping relationship(s) between the RRH IDs/indices and the RSs for RRH clustering. Alternatively, if the UE anyways needs to report to the network the measurement results, the UE could indicate to the network the association(s) between different reports such that the RRHs corresponding to the associated reports are regarded as the RRH cluster for the UE. This requires the UE and the network to have a common understanding of how the RRH IDs/indices and the reports are associated/mapped.

For instance, the UE could be indicated by the network the association rule(s)/mapping relationship(s) between the RRH IDs/indices and the reports. For another example, the UE could autonomously determine the association rule(s)/mapping relationship(s) between the RRH IDs/indices and the reports, and indicate to the network the association rule(s)/mapping relationship(s). The UE could be configured by the network through higher layer RRC signaling whether the UE could autonomously determine their RRH cluster and/or indicate to the network the RRH clustering results. The UE could also send a status report to the network indicating whether the UE has autonomously determined their RRH cluster.

In one example of Option-3, the UE could transmit certain preambles such as sounding reference signals (SRSs) to the RRHs to assist RRH clustering. Based on the measurements of the UL preambles for RRH clustering, the network could determine the RRH cluster for the UE of interest. The UE could then be configured/indicated by the network via higher layer RRC signaling the RRH clustering results, which could comprise of the corresponding RRH IDs/indices, a primary RRH ID/index, and etc.

In one example of Option-4, the UE could be first configured by the network to transmit certain preambles such as sounding reference signals (SRSs) to the RRHs to assist RRH clustering (e.g., Option-3). Based on the measurements of the UL preambles for RRH clustering, the UE could be further configured by the network to measure one or more reference signals (RSs) for RRH clustering from one or more RRHs (e.g., Option-1). The UE could then report to the network the corresponding measurement results (i.e., as a CSI report), upon which the network could determine the RRH cluster for the UE of interest. The UE could be configured/indicated by the network via higher layer RRC signaling the RRH clustering results, which could comprise of the corresponding RRH IDs/indices, a primary RRH ID/index, and etc.

The UE could be indicated/configured by the network via higher layer RRC signaling which option from Option-1, Option-2, and Option-3 to follow for configuring/determining the RRH cluster.

Due to channel variations, the RRH cluster for a UE could vary over time. For Option-1 and Option-2, the UE could be configured by the network to periodically measure the DL RSs for RRH clustering and/or report to the network the measurement results. The UE could also be requested/triggered by the network to measure the DL RSs for RRH clustering and/or report to the network the corresponding measurement results in an aperiodic manner. For Option-3, the UE could be configured by the network to periodically transmit to the network the UL preambles for RRH clustering.

Alternatively, the UE could be requested/triggered by the network to transmit the UL preambles for RRH clustering in an aperiodic manner. For Option-1, Option-2 and Option-3, the UE could indicate to the network (i.e., UE-initiated approach) that a new RRH cluster is needed so that the network could configure (additional) DL RSs for RRH clustering for the UE to measure and report and/or the UE to transmit (additional) UL preambles for RRH clustering. Further, the UE could be configured by the network two timers (a first timer and a second timer). The UE could reset both timers if a new RRH cluster is configured and applied for the UE. The UE would not apply another new RRH cluster before the first timer expires. If the second timer expires, the UE would indicate to the network that a new RRH cluster is needed.

In the following description, an RRH can represent a collection of measurement antenna ports or measurement RS resources. For example, an RRH can be associated with a plurality of CSI-RS resources or CRIs (CSI-RS resource indices/indicators). Optionally, an RRH can be associated with a measurement RS resource set—or, for example, CSI resource set along with its indicator.

The term “RRH group” can represent a cluster of RRHs and, hence, a group of collections of measurement RS resources or a group of measurement RS resource sets.

In a distributed RRH system, the RRH cluster for a given UE could comprise of one or more RRH groups. Each RRH group could contain one or more RRHs. The RRHs in each RRH group could have similar propagation delays with the UE such that their propagation delay differences (i.e., relative propagation delays) are smaller than the CP length.

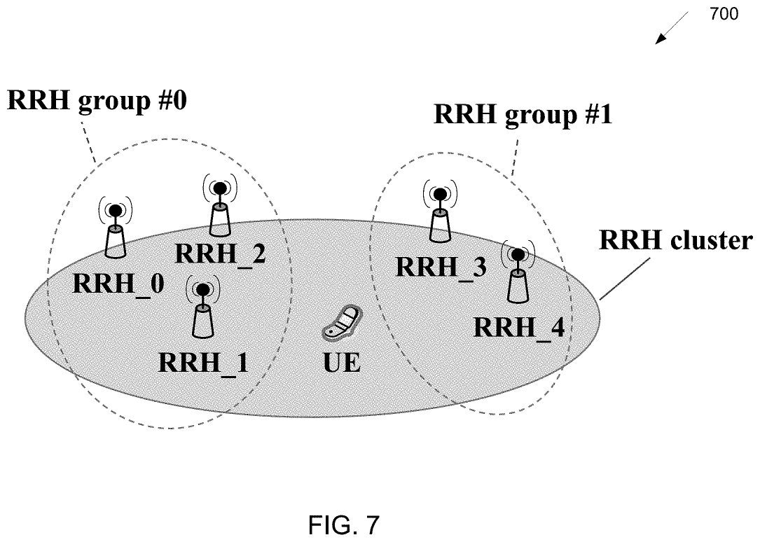

FIG. 7 illustrate an example of RRH groups and clusters in a distributed RRH system 700 according to embodiments of the present disclosure. An embodiment of the RRH groups and clusters in the distributed RRH system 700 shown in FIG. 7 is for illustration only.

As illustrated in FIG. 7, a conceptual example characterizing a RRH cluster and two RRH groups for a given UE is presented. As can be seen from FIG. 7, the RRH cluster for the UE contains RRH group #0 and RRH group #1. RRH group #0 contains RRH_0, RRH_1 and RRH_2, and RRH group #1 contains RRH_3 and RRH_4.

Similar to the configuration of a RRH cluster, there are various means to configure a RRH group or RRH groups within a given RRH cluster in a distributed RRH system. The configuration/determination of the RRH group(s) could be after the configuration/determination of the RRH cluster.

In one example of Option-I, the UE could be configured by the network to measure one or more RSs for RRH grouping from one or more RRHs. The UE could then report to the network the corresponding measurement results, upon which the network could determine the RRH groups within the RRH cluster for the UE of interest. The measurement results could be based on the propagation delays between the RRHs in the RRH cluster and the UE. The UE could be configured/indicated by the network the RRH grouping results, which could comprise of the RRH group IDs/indices, the corresponding RRH IDs/indices within each RRH group, primary RRH IDs/indices within each RRH group, and etc. Under certain settings, the RRH grouping results are transparent to the UE, i.e., they are not indicated to the UE from the network.

In such example, to facilitate measuring the RSs for RRH grouping from different RRHs and reporting the measurement results, the RSs for RRH grouping from different RRHs could be multiplexed in time, frequency, spatial and/or code domains. For instance, the UE could be configured by the network to measure the RSs for RRH grouping from different RRHs in different symbols/slots/etc. For another example, the UE could be configured by the network to measure the RSs for RRH grouping from different RRHs in different resource blocks. The UE could also be indicated by the network the association rule(s)/mapping relationship(s) between the RRH IDs/indices and the RSs for RRH grouping. In this case, the UE could know which RRH(s) in the RRH cluster the corresponding RSs for grouping are transmitted from.

In such example, to facilitate measuring the RSs for RRH grouping from different RRHs and reporting the measurement results, the UE could be configured by the network to report the measurement results through certain time, frequency, spatial and/or code domain resources. For instance, the UE could be configured by the network to report the measurement results for different RRHs within the RRH cluster through different symbols/slots/etc. For another example, the UE could be configured by the network to report the measurement results for different RRHs within the RRH cluster on different resource blocks. The UE could be indicated by the network the association rule(s)/mapping relationship(s) between the RSs for RRH grouping and the reports and/or between the RRH IDs/indices within the RRH cluster and the reports. Alternatively, the UE could autonomously determine the association rule(s)/mapping relationship(s) between the RSs for RRH grouping (or the RRH IDs/indices) and the reports, and indicate to the network the association rule(s)/mapping relationship(s).

In such example, to facilitate measuring the RSs for RRH grouping from different RRHs and reporting the measurement results, as indicated above, the measurement results/reports for RRH grouping could be based on the propagation delays between the RRHs in the RRH cluster and the UE. For instance, the UE could report to the network the propagation delay between each RRH in the RRH cluster and the UE. For another example, the UE could report to the network the differences between the propagation delay of one selected RRH and the propagation delays of the rest of the RRHs in the same RRH cluster.

In one example of Example-1, for determining and reporting the propagation delay differences, the UE determines one RRH from the RRHs in the RRH cluster based on the propagation delay measurements. For instance, the selected reference RRH could have the largest propagation delay with the UE among all the RRHs in the RRH cluster. For another example, the UE could select the RRH that has the smallest propagation delay among all the RRHs in the RRH cluster. The UE could report to the network the propagation delay between the reference RRH and the UE. In addition, the UE could report to the network the differences between the propagation delay of the selected reference RRH and the propagation delays of the other RRHs in the RRH cluster (differential reports). The UE could also report a sign indicator associated with a differential report. The sign indicator indicates whether the propagation delay of the corresponding RRH is smaller or larger than that of the reference RRH.

In one example of Example-1.1, the UE incorporates an indicator in the report associated with the selected reference RRH; other reports not associated with the indicator are regarded as the differential reports.

In one example of Example-1.2, the UE incorporates a 1-bit indicator (“0” or “F”) in all the reports associated with all the RRHs in the RRH cluster. For instance, “0” indicates that the report is a differential report, while “F” implies that the report corresponds to the propagation delay of the selected reference RRH.

In one example of Example-1.3, the UE reports to the network the RRH ID/index of the selected reference RRH.

In one example of Example-2, for determining and reporting the propagation delay differences, the UE could be indicated by the network the RRH ID/index of the reference RRH. For instance, the reference RRH could have the lowest RRH ID/index among all the RRHs in the RRH cluster. Alternatively, the UE could be indicated by the network which RSs are transmitted from the reference RRH. The UE could then report to the network the propagation delay between the reference RRH and the UE through the dedicated resource(s). The UE could also send the differential reports to the network for the other RRHs in the RRH cluster. Along with each differential report, the UE could associate a sign indicator to indicate whether the propagation delay between the RRH of interest and the UE is smaller or larger than that between the reference RRH and the UE.

The UE could be configured/indicated by the network through higher layer RRC signaling whether to directly report the propagation delay for each RRH in the RRH cluster or perform the differential reporting.

In one embodiment of Option-II, the UE could autonomously determine their RRH group(s) based on the measurement results of the DL RSs for RRH grouping from different RRHs. The UE could indicate to the network the RRH grouping results, which could comprise of the RRH group IDs/indices, the corresponding RRH IDs/indices within each RRH group, primary RRH IDs/indices within each RRH group, and etc. In this case, the UE needs to be indicated by the network the association rule(s)/mapping relationship(s) between the RRH IDs/indices in the RRH cluster and the RSs for RRH grouping.

Alternatively, if the UE anyways needs to report to the network the measurement results, the UE could indicate to the network the association(s) between different reports such that the RRHs corresponding to the associated reports are regarded as one RRH group for the UE. For instance, the UE could incorporate a reporting ID in each report such that reports having the same reporting ID are associated. This requires the UE and the network to have a common understanding of how the RRH IDs/indices and the reports are associated/mapped.

For instance, the UE could be indicated by the network the association rule(s)/mapping relationship(s) between the RRH IDs/indices and the reports. For another example, the UE could autonomously determine the association rule(s)/mapping relationship(s) between the RRH IDs/indices and the reports, and indicate to the network the association rule(s)/mapping relationship(s). The UE could be configured by the network through higher layer RRC signaling whether the UE could autonomously determine their RRH group(s) and/or indicate to the network the RRH grouping results. The UE could also send a status report to the network indicating whether the UE has autonomously determined their RRH group(s).

In one embodiment of Option-III, the UE could transmit certain preambles such as SRSs to the RRHs in the RRH cluster to assist RRH grouping. Based on the measurements of the UL preambles for RRH grouping, the network could determine the RRH group(s) for the UE of interest. The UE could then be configured/indicated by the network via higher layer RRC signaling the RRH grouping results, which could comprise of the RRH group IDs/indices, the corresponding RRH IDs/indices within each RRH group, primary RRH IDs/indices within each RRH group, and etc.

In one embodiment of Option-IV, the UE could be first configured by the network to transmit certain preambles such as sounding reference signals (SRSs) to the RRHs to assist RRH grouping (e.g., Option-III). Based on the measurements of the UL preambles for RRH grouping, the UE could be further configured by the network to measure one or more reference signals (RSs) for RRH grouping from one or more RRHs (e.g., Option-I). The UE could then report to the network the corresponding measurement results (i.e., as a CSI report), upon which the network could determine the RRH group(s) for the UE of interest. The UE could be configured/indicated by the network via higher layer RRC signaling the RRH grouping results, which could comprise of the corresponding RRH IDs/indices, a primary RRH ID/index, and etc.

The UE could be configured/indicated by the network which option from Option-I, Option-II and Option-III to follow for configuring/determining the RRH group(s).

Due to channel variations, the RRH groups in the same RRH cluster for a UE could vary over time. For Option-I and Option-II, the UE could be configured by the network to periodically measure the DL RSs for RRH grouping and/or report to the network the measurement results. The UE could also be requested/triggered by the network to measure the DL RSs for RRH grouping and/or report to the network the corresponding measurement results in an aperiodic manner.

For Option-III, the UE could be configured by the network to periodically transmit to the network the UL preambles for RRH grouping. Alternatively, the UE could be requested/triggered by the network to transmit the UL preambles for RRH grouping in an aperiodic manner. For Option-I, Option-II, and Option-III, the UE could indicate to the network that new RRH groups are needed so that the network could configure (additional) DL RSs for RRH grouping for the UE to measure and report and/or the UE to transmit (additional) UL preambles for RRH grouping.

Further, the UE could be configured by the network two timers (a third timer and a fourth timer). The UE could reset both timers if new RRH groups in the RRH cluster are configured and applied for the UE. The UE would not apply new RRH grouping results before the third timer expires. If the fourth timer expires, the UE would indicate to the network that new RRH groups are needed for the RRH cluster.

The UE could be configured by the network separate sets of RSs for RRH clustering and RRH grouping. Alternatively, the UE could be configured by the network the same RSs for both RRH clustering and RRH grouping. Similarly, the UE could use either separate sets of UL preambles or a common set of UL preambles for RRH clustering and RRH grouping, which could be configured by the network through higher layer RRC signaling. Further, the configuration of the RRH clustering results to the UE could also trigger the UE to measure the DL RSs for RRH grouping, or transmit the UL preambles for RRH grouping, or autonomously determine the RRH grouping results. The UE could be indicated by the network whether the RRH clustering/grouping is enabled.

For instance, if the UE is configured by the network that the RRH clustering is “enabled,” the UE could follow Option-1, Option-2, or Option-3 to determine the RRH cluster. For another example, if the UE is configured by the network that the RRH grouping is “disabled,” the UE would not expect to measure any DL RSs for RRH grouping and report the measurement results, transmit any UL preambles for RRH grouping, or autonomously determine the RRH grouping results.

In one example, a RRH cluster or a RRH group contains at least one RRH. As discussed above, the UE could be indicated/configured by the network through higher layer RRC signaling the RRH grouping results such as the RRH group IDs/indices of the RRH groups in the RRH cluster. The UE could receive from the network a MAC-CE command to activate one or more RRH groups (active RRH groups) from all the RRH groups in the RRH cluster. Alternatively, the UE could be indicated by the network via DCI signaling one or more RRH groups from all the RRH groups in the RRH cluster as the active RRH group(s). For a given (period of) time, the UE could only communicate with the active RRH group(s) in the RRH cluster.

In another example, a RRH cluster could correspond to all RRHs in the distributed RRH system. In this case, the UE could be higher layer configured/indicated by the network that the RRH clustering is disabled, or the UE could be higher layer configured not to measure the RSs for RRH clustering, and/or the UE could be higher layer configured/indicated by the network that the RRH cluster would contain all RRHs in the distributed RRH system.

In another example, a RRH group could correspond to all RRHs in the RRH cluster configured for the UE, i.e., a RRH group is equivalent to a RRH cluster. In this case, the UE could be higher layer configured/indicated by the network that the RRH grouping is disabled, or the UE could be higher layer configured not to measure the RSs for RRH grouping, and/or the UE could be higher layer configured/indicated by the network that the RRH group would contain all RRHs in the RRH cluster configured for the UE.

In another example, the UE could perform a two-step measurement and reporting for the RRH clustering and the RRH grouping.

For example, the UE could first perform measurement and reporting for the RRH clustering (step-1), followed by measurement and reporting for the RRH grouping (step-2).

For another example, the UE could first perform separate measurements for the RRH clustering and RRH grouping, e.g., using separate RSs (step-1), followed by sending to the network separate RRH clustering and RRH grouping measurement reports, e.g., in separate time slots (step-2).

Yet for another example, the UE could first perform separate measurements for the RRH clustering and RRH grouping, e.g., using separate RSs (step-1), followed by sending to the network a joint RRH clustering and RRH grouping measurement report, e.g., in a single time slot.

Yet for another example, the UE could first perform a joint measurement for the RRH clustering and RRH grouping, e.g., using a common RS (step-1), followed by sending to the network separate RRH clustering and RRH grouping measurement reports, e.g., in separate time slots (step-2).

Yet for another example, the UE could first perform a joint measurement for the RRH clustering and RRH grouping, e.g., using a common RS (step-1), followed by sending to the network a joint RRH clustering and RRH grouping measurement report, e.g., in a single time slot (step-2).

In the following description, an RRH can represent a collection of measurement antenna ports or measurement RS resources. For example, an RRH can be associated with a plurality of CSI-RS resources or CRIs (CSI-RS resource indices/indicators). Optionally, an RRH can be associated with a measurement RS resource set—or, for example, CSI resource set along with its indicator.

The term “RRH group” can represent a cluster of RRHs and, hence, a group of collections of measurement RS resources or a group of measurement RS resource sets.

The UE provides to the network the downlink channel conditions via the CSI reporting. The CSI could comprise of one or more of the following information, such as CSI-RS resource indicator (CRI), rank indicator (RI), precoding matrix indicator (PMI), channel quality indicator (CQI) and etc. In the 5G NR, the CSI reporting could be explicitly triggered/requested by the network in an aperiodic manner through some form of signaling, such as via a CSI request field in a DCI or a flag in an uplink scheduling grant. Further, the A-CSI report(s) could be multiplexed on PUSCH, on dynamically assigned resource(s).

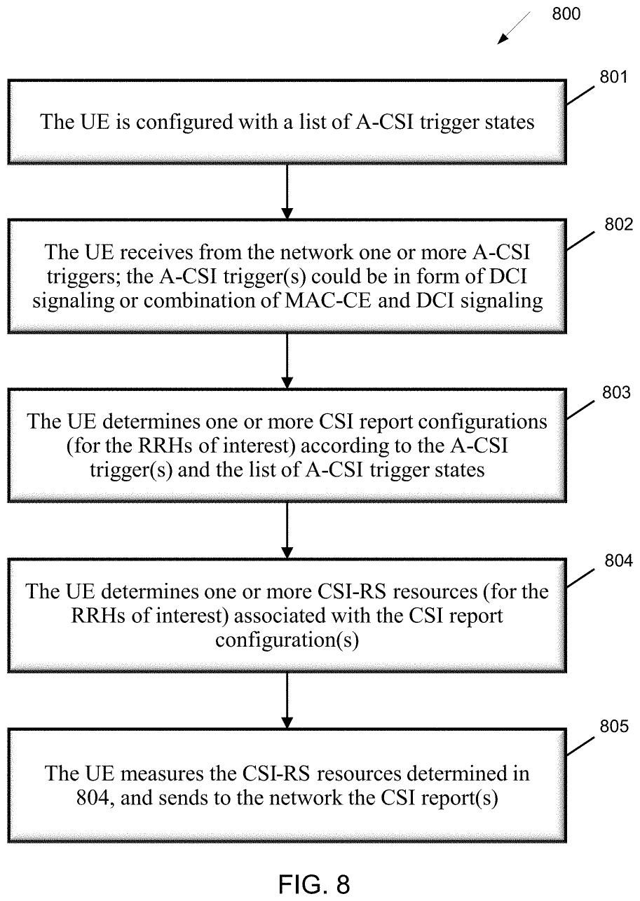

FIG. 8 illustrates a flowchart of method 800 for A-CSI resource configuration, triggering, measurement and reporting procedure according to embodiments of the present disclosure. The method 800 as may be performed by a UE (e.g., 111-116 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

In FIG. 8, an example depicting the A-CSI triggering, measurement and reporting procedure for the distributed RRH system is provided.

In 801, the UE is higher layer configured by the network a list of A-CSI trigger states (e.g., via higher layer parameter aperiodicTriggerStateList). Each candidate A-CSI trigger state in the list of A-CSI trigger states contains one or more CSI report configurations/settings. The CSI report configuration(s)/setting(s) could be associated with the RRHs in the RRH cluster for the UE.

In 802, the UE receives from the network one or more A-CSI triggers through either DCI signaling only or a combination of MAC-CE and DCI signaling. One A-CSI trigger could indicate one candidate A-CSI trigger state in the list of A-CSI trigger states configured to the UE in 501, and therefore, the corresponding CSI report configuration(s)/setting(s) therein. For instance, the A-CSI trigger could be in form of the CSI request in DCI format 1_0, which specifies the index of the A-CSI trigger state of interest in the list of A-CSI trigger states.

Denote the number of bits in the DCI CSI request field by N_{TS}, where N_{TS}ϵ{0, 1, 2, . . . , N_{C}} Both N_{TS} and N_{C} could be determined according to various factors such as the number of RRHs in the RRH cluster for the UE, and configured to the UE by the network via higher layer RRC signaling. When the number of candidate A-CSI trigger states (denoted by Ntot) in the list of A-CSI trigger states is less than or equal to 2^{N}^{_{TS}}−1 (i.e., the bit length of the DCI CSI request field is larger than or equal to the total number of candidate A-CSI trigger states in the list of A-CSI trigger states), the DCI CSI request would directly point to the A-CSI trigger state of interest in the list of A-CSI trigger states.

When the number of candidate A-CSI trigger states Ntot in the list of A-CSI trigger states is greater than 2^{N}^{_{TS}}−1 (i.e., the bit length of the DCI CSI request field is smaller than the total number of candidate A-CSI trigger states in the list of A-CSI trigger states), the UE receives from the network a MAC-CE subselection indication (A-CSI trigger state subselection MAC-CE), which is used to map up to N_{S} A-CSI trigger states to the codepoints of the CSI request field in DCI. In this case, the DCI CSI request (i.e., the A-CSI trigger) would point to the codepoint index, and therefore, the corresponding A-CSI trigger state of interest, in the A-CSI trigger state subselection MAC-CE containing a subset of all candidate A-CSI trigger states in the list of A-CSI trigger states.

In 803, the UE determines one or more CSI report configurations/settings associated with the configured A-CSI trigger state(s). As discussed in 803, the A-CSI trigger(s) indicates the A-CSI trigger state(s) from either the list of all candidate A-CSI trigger states (e.g., configured to the UE via the higher layer parameter aperiodicTriggerStateList) or a subset of all candidate A-CSI trigger states activated in MAC-CE. The CSI report configuration(s)/setting(s) could be associated with different RRHs in the distributed RRH system, e.g., the RRHs in the RRH cluster configured for the UE. The detailed association methods/options between the CSI report configuration(s)/setting(s) and the RRHs are discussed in later parts of this disclosure.

In 804, the UE determines one or more CSI-RS resources associated with the CSI report configuration(s)/setting(s) determined in 803. The CSI-RS resource(s) could be associated with different RRHs in the distributed RRH system, e.g., the RRHs in the RRH cluster configured for the UE. The detailed association methods/options between the CSI resource configuration(s)/setting(s) and the RRHs are discussed in later parts of this disclosure.

In 805, the UE measures the CSI-RS resources (determined in 804) from different RRHs (e.g., the RRHs in the RRH cluster configured for the UE) following the corresponding CSI resource configuration(s)/setting(s), and sends to the network the CSI report(s) for different RRHs (e.g., the RRHs in the RRH cluster configured for the UE) following the corresponding CSI report configuration(s)/setting(s).

The UE could be configured with one large codebook of Σᵣ₌₁^{Nrrh} Pᵣ CSI-RS ports for all RRHs in the RRH cluster. Alternatively, for each RRH in the RRH cluster configured for the UE, the UE could be configured with a codebook Cᵣ of Pᵣ CSI-RS ports (e.g., via one higher layer parameter codebookType or via Nrrh higher layer parameter, one for each RRH). That is, the UE could be configured to use Nrrh codebooks, each of Pᵣ CSI-RS ports.

In one example of Configuration-0A, the A-CSI trigger state is associated with one CSI-RS resource in one CSI resource set and one CSI report setting, which are also associated with the RRHs in the RRH cluster configured for the UE.

In one example of CSI resource setting for Configuration-0A, the UE is higher layer configured with M=1 CSI resource setting, and the configured CSI resource setting comprises of S=1 CSI resource set, which further includes one CSI-RS resource. The CSI-RS resource comprising of P=Σᵣ₌₁^{Nrrh} Pᵣ CSI-RS ports, which can be partitioned into Nrrh port groups, which could be regarded/labelled as the first port group, the second port group, and so on, and the Nrrh-th port group. The r-th port group is associated with r-th RRH and comprises of Pᵣ CSI-RS ports.

In one example of Option-0A.1, the mapping/association between the Nrrh port groups and the Nrrh RRHs in the RRH cluster configured for the UE can be established in an implicit manner. For instance, the first port group could be associated with the first RRH, the second port group could be associated with the second RRH, and so on, and the Nrrh-th port group could be associated with the last RRH.

In one example, the first RRH could correspond to the first RRH in a list of RRHs configured to the UE, the second RRH could correspond to the second RRH in the list of RRHs configured to the UE, and so on, and the last RRH could correspond to the last RRH in the list of RRHs configured to the UE.

In another example, the first RRH could correspond to the RRH with the lowest RRH ID value, the second RRH could correspond to the RRH with the second lowest RRH ID value, and so on, and the last RRH could correspond to the RRH with the highest RRH ID value. Other implicit mapping/association rules between the Nrrh port groups and the Nrrh RRHs in the RRH cluster are also possible, and they may be known to the UE a prior.

In one example of Option-0A.2, the UE could be explicitly indicated by the network the mapping relationship/association rule between the Nrrh port groups and the Nrrh RRHs in the RRH cluster configured for the UE. This indication could be via higher layer (RRC) or/and MAC CE or/and DCI based signaling. In one example, this indication is via a separate (dedicated) parameter or joint with another parameter. Likewise, this indication could be together with the CSI reporting settings (e.g., in the higher layer parameter CSI-reportConfig) or together with the CSI resource settings (e.g., in the higher layer parameter CSI-resourceConfig) or together with the CSI request field triggering the CSI reporting.

Further, this indication could also be together with the indication of RRH clustering and/or RRH grouping. In one example, the UE could be configured by the network a RRH ID list containing Nrrh RRH IDs or RRH-specific higher layer signaling indices. For instance, the first port group could be associated with the first entry (and therefore, the corresponding RRH ID/RRH-specific higher layer signaling index) in the RRH ID list, the second port group could be associated with the second entry (and therefore, the corresponding RRH ID/RRH-specific higher layer signaling index) in the RRH ID list, and so on, and the Nrrh-th port group could be associated with the last entry (and therefore, the corresponding RRH ID/RRH-specific higher layer signaling index) in the RRH ID list. Other explicit methods of indicating the mapping relationship/association rule between the Nrrh port groups and the Nrrh RRHs in the RRH cluster are also possible.

For both Option-0A.1 and Option-0A.2, the UE may be higher layer configured by the network how the CSI-RS ports are partitioned into Nrrh port groups. For instance, for Nrrh=2, the first port group could contain the first half of the total CSI-RS ports, while the second port group could contain the second half of the total CSI-RS ports configured in the CSI-RS resource.

Alternatively, the UE could receive a MAC-CE based activation command indicating how the CSI-RS ports are partitioned into Nrrh port groups. For example, a MAC-CE message (such as a bit sequence) can be used for this purpose. The UE could also be indicated via dynamic DCI based triggering how the CSI-RS ports are partitioned into Nrrh port groups. For instance, code points of a parameter in the DCI can be used for this purpose.

There are various other configuration/indication methods discussed below: (1) the partition of the CSI-RS ports into Nrrh port groups is based on a combination of higher layer (RRC) configuration and MAC CE activation; (2) the partition of the CSI-RS ports into Nrrh port groups is based on a combination of higher layer (RRC) configuration and DCI based triggering; (3) the partition of the CSI-RS ports into Nrrh port groups is based on a combination of MAC CE activation and DCI based triggering; and/or (4) the partition of the CSI-RS ports into Nrrh port groups is based on a combination of higher layer (RRC) configuration, MAC CE activation, and DCI based triggering.

In one example of CSI report setting for Configuration-0A, the UE is higher layer configured with P=1 CSI report setting. The single CSI report setting is associated with all Nrrh RRHs in the RRH cluster configured for the UE. The P=1 CSI report setting can include one CSI report across all RRHs in the RRH cluster or more than one (e.g., one CSI report per RRH in the RRH cluster) CSI reports. A few examples of such reporting contents are provided in the U.S. patent application Ser. No. 17/673,621 filed Feb. 16, 2022, which is incorporated by reference herein.

The UE can report all of or a subset of the Nrrh CSI reports dynamically, i.e., the UE could report X Nrrh CSI reports, {CSI(x), x=0, 1, . . . , X−1}, where the value of K could be fixed, or configured to the UE via RRC, or MAC-CE, or DCI, or a combination of at least two of RRC, MAC-CE, and DCI, or autonomously determined by the UE and reported to the network as part of the CSI report and/or a separate CSI parameter and/or jointly with another parameter such as RI, CRI and etc.

If the value of X is chosen dynamically by the UE, the X CSI reports can be partitioned into two parts, CSI part 1 and CSI part 2. In one example, the CSI part 1 and part 2 are as follows: (1) the CSI part 1 includes x₁<X CSI reports, where x₁ is fixed or configured (e.g., x₁=1), and an indication about the remaining x₂=X−x₁ CSI reports. This information can be a bitmap of length Nrrh. The payload (number of bits) of the CSI part 1 is fixed; and/or (2) the CSI part 2 includes the remaining x₂ CSI reports. The payload of the CSI part 2 is variable depending on the value of x₂. In one example, x₂=0 is allowed. In one example, x₂>0.

The two parts of the CSI report can be transmitted (reported) by the UE via a two-part UCI (cf. Rel. 15 two-part UCI). The details about this two-part UCI can be according to the U.S. Patent Application Publication No. 2020/0084006 filed Sep. 10, 2019, and U.S. Pat. No. 10,958,326 issued Mar. 23, 2021, both of which are incorporated by reference herein.

In one example of A-CSI trigger state for Configuration-0A, the A-CSI trigger state for Configuration-0A corresponds to one CSI report setting/configuration, which is associated with a cluster of Nrrh RRHs configured for the UE. Further, the CSI report setting is linked to one CSI resource setting comprising of one CSI resource set. In the CSI resource set, one CSI-RS resource is configured for a total of Σr₌₁^{Nrrh} Pᵣ CSI-RS ports. The total CSI-RS ports are partitioned into Nrrh port groups, which are associated with the cluster of Nrrh RRHs configured for the UE following Option-0A.1 and/or Option-0A.2.

In one example of Configuration-0B, the A-CSI trigger state is associated with one CSI-RS resource in one CSI resource set and multiple (more than one) CSI report settings, which are also associated with the RRHs in the RRH cluster configured for the UE.

In one example of CSI resource setting for Configuration-0B, the CSI resource setting for Configuration-0B is the same as that for Configuration-0A. That is, the UE is higher layer configured with M=1 CSI resource setting, and the configured CSI resource setting comprises of S=1 CSI resource set, which further includes one CSI-RS resource. The CSI-RS resource comprising of P=Σᵣ₌₁^{Nrrh} CSI-RS ports, which can be partitioned into Nrrh port groups, which P could be regarded/labelled as the first port group, the second port group, and so on, and the Nrrh-th port group. The r-th port group is associated with r-th RRH and comprises of Pᵣ CSI-RS ports. The detailed association rule(s)/mapping relationship(s) between the Nrrh port groups and the Nrrh RRHs in the RRH cluster configured for the UE could follow those discussed in Option-0A.1 and Option-0A.2.

In one example of CSI report setting for Configuration-0B, the UE is higher layer configured with P>1 CSI report settings, which could be regarded/labelled as the first CSI report setting, the second CSI report setting, and so on, and the P-th CSI report setting. Each CSI report setting could be associated with one or more RRHs in the RRH cluster configured for the UE. If P<Nrrh, a single CSI report setting could be associated with more than one RRH in the RRH cluster. If P=Nrrh, a single RRH in the RRH cluster could be associated with a single CSI report setting. If P>Nrrh, a single RRH in the RRH cluster could be associated with more than one CSI report setting.

In one example of Option-0B.1, the mapping/association between the P CSI resource settings and the Nrrh RRHs in the RRH cluster configured for the UE can be established in an implicit manner. For instance, for P=Nrrh, the first CSI report setting could be associated with the first RRH, the second CSI report setting could be associated with the second RRH, and so on, and the P-th CSI report setting could be associated with the last RRH. In one example, the first RRH could correspond to the first RRH in a list of RRHs configured to the UE, the second RRH could correspond to the second RRH in the list of RRHs configured to the UE, and so on, and the last RRH could correspond to the last RRH in the list of RRHs configured to the UE. In another example, the first RRH could correspond to the RRH with the lowest RRH ID value, the second RRH could correspond to the RRH with the second lowest RRH ID value, and so on, and the last RRH could correspond to the RRH with the highest RRH ID value. Other implicit mapping/association rules between the P CSI report settings and the Nrrh RRHs in the RRH cluster are also possible, and they may be known to the UE a prior.

In one example of Option-0B.2, the UE could be explicitly indicated by the network the mapping relationship/association rule between the P CSI report settings and the Nrrh RRHs in the RRH cluster configured for the UE. This indication could be via higher layer (RRC) or/and MAC CE or/and DCI based signaling. In one example, this indication is via a separate (dedicated) parameter or joint with another parameter. Likewise, this indication could be together with the CSI reporting settings (e.g., in the higher layer parameter CSI-reportConfig) or together with the CSI resource settings (e.g., in the higher layer parameter CSI-resourceConfig) or together with the CSI request field triggering the CSI reporting. Further, this indication could also be together with the indication of RRH clustering and/or RRH grouping.

In one example, the UE could be configured by the network a RRH ID list containing Nrrh RRH IDs or RRH-specific higher layer signaling indices. For instance, for P=Nrrh, the first CSI report setting could be associated with the first entry (and therefore, the corresponding RRH ID/RRH-specific higher layer signaling index) in the RRH ID list, the second CSI report setting could be associated with the second entry (and therefore, the corresponding RRH ID/RRH-specific higher layer signaling index) in the RRH ID list, and so on, and the P-th CSI report setting could be associated with the last entry (and therefore, the corresponding RRH ID/RRH-specific higher layer signaling index) in the RRH ID list. Other explicit methods of indicating the mapping relationship/association rule between the P CSI report settings and the Nrrh RRHs in the RRH cluster are also possible.

The UE can report all of or a subset of the P CSI reports dynamically (here, each CSI report is associated with a separate CSI report setting), i.e., the UE could report Y≤P CSI reports, {CSI(y), y=0, 1, . . . , Y−1}, where the value of Y could be fixed, or configured to the UE via RRC, or MAC-CE, or DCI, or a combination of at least two of RRC, MAC-CE, and DCI, or autonomously determined by the UE and reported to the network as part of the CSI report and/or a separate CSI parameter and/or jointly with another parameter such as RI, CRI and etc.

If the value of Y is chosen dynamically by the UE, the Y CSI reports can be partitioned into two parts, CSI part 1 and CSI part 2. In one example, the CSI part 1 and part 2 are as follows: (1) the CSI part 1 includes y₁<Y CSI reports, where y₁ is fixed or configured (e.g., y₁=1), and an indication about the remaining y₂=Y−y₁ CSI reports. This information can be a bitmap of length P. The payload (number of bits) of the CSI part 1 is fixed; and (2) the CSI part 2 includes the remaining y₂ CSI reports. The payload of the CSI part 2 is variable depending on the value of y₂. In one example, y₂=0 is allowed. In one example, y₂>0.

The two parts of the CSI report can be transmitted (reported) by the UE via a two-part UCI (cf. Rel. 15 two-part UCI).

In one example of A-CSI trigger state for Configuration-0B, the A-CSI trigger state for Configuration-0B corresponds to P>1 CSI report settings/configurations, which are associated with a cluster of Nrrh RRHs configured for the UE following Option-0B.1 and/or Option-0B.2. Further, the P CSI report settings are linked to one CSI resource setting comprising of one CSI resource set. In the CSI resource set, one CSI-RS resource is configured for a total of Σᵣ₌₁^{Nrrh} Pᵣ CSI-RS ports. The total CSI-RS ports are partitioned into Nrrh port groups, which are associated with the cluster of Nrrh RRHs configured for the UE following Option-0A.1 and/or Option-0A.2. From the above discussions, if the port groups and the CSI report setting(s) are associated with the same RRH(s), they are implicitly linked to each other.

In one example of Configuration-1A, the A-CSI trigger state is associated with one or more CSI-RS resources in one CSI resource set and one CSI report setting, which are also associated with the RRHs in the RRH cluster configured for the UE.

In one example of CSI resource setting for Configuration-1A, the UE is higher layer configured with M=1 CSI resource setting, and the configured CSI resource setting comprises of S=1 CSI resource set. The Ks≥1 CSI-RS resources configured in the CSI resource set are divided into Ms≥1 CSI-RS resource subsets, which could be regarded/labeled as the first CSI-RS resource subset, the second CSI-RS resource subset, and so on, and the Ms-th CSI-RS resource subset; each CSI-RS resource subset, and therefore the CSI-RS resources therein, could be associated with one or more RRHs in the RRH cluster for the UE. Denote the number of RRHs in the RRH cluster for the UE by Nrrh. A single RRH in the RRH cluster could be associated with a single CSI-RS resource subset. Further, for Ms>Nrrh, a single RRH in the RRH cluster could be associated with more than one CSI-RS resource subsets. In addition, for Ms<Nrrh, a single CSI-RS resource subset could be associated with more than one RRH in the RRH cluster.

In one example of Option-1A.1, the mapping/association between the Ms CSI-RS resource subsets and the Nrrh RRHs in the RRH cluster configured for the UE can be established in an implicit manner. For instance, for Ms=Nrrh, the first CSI-RS resource subset containing one or more CSI-RS resources could be associated with the first RRH, the second CSI-RS resource subset containing one or more CSI-RS resources could be associated with the second RRH, and so on, and the Ms-th CSI-RS resource subset containing one or more CSI-RS resources could be associated with the last RRH. In one example, the first RRH could correspond to the first RRH in a list of RRHs configured to the UE, the second RRH could correspond to the second RRH in the list of RRHs configured to the UE, and so on, and the last RRH could correspond to the last RRH in the list of RRHs configured to the UE. In another example, the first RRH could correspond to the RRH with the lowest RRH ID value, the second RRH could correspond to the RRH with the second lowest RRH ID value, and so on, and the last RRH could correspond to the RRH with the highest RRH ID value. Other implicit mapping/association rules between the Ms CSI-RS resource subsets and the Nrrh RRHs in the RRH cluster are also possible, and may may be known to the UE a prior.

In one example of Option-1A.2, the UE could be explicitly indicated by the network the mapping relationship/association rule between the Ms CSI-RS resource subsets (and therefore, the corresponding CSI-RS resources therein) and the Nrrh RRHs in the RRH cluster configured for the UE. This indication could be via higher layer (RRC) or/and MAC CE or/and DCI based signaling. In one example, this indication is via a separate (dedicated) parameter or joint with another parameter. Likewise, this indication could be together with the CSI reporting settings (e.g., in the higher layer parameter CSI-reportConfig) or together with the CSI resource settings (e.g., in the higher layer parameter CSI-resourceConfig) or together with the CSI request field triggering the CSI reporting. Further, this indication could also be together with the indication of RRH clustering and/or RRH grouping.

In one example, the UE could be configured by the network a RRH ID list containing Nrrh RRH IDs or RRH-specific higher layer signaling indices. For instance, for Ms=Nrrh, the first CSI-RS resource subset containing one or more CSI-RS resources could be associated with the first entry (and therefore, the corresponding RRH ID/RRH-specific higher layer signaling index) in the RRH ID list, the second CSI-RS resource subset containing one or more CSI-RS resources could be associated with the second entry (and therefore, the corresponding RRH ID/RRH-specific higher layer signaling index) in the RRH ID list, and so on, and the Ms-th CSI-RS resource subset containing one or more CSI-RS resources could be associated with the last entry (and therefore, the corresponding RRH ID/RRH-specific higher layer signaling index) in the RRH ID list. Other explicit methods of indicating the mapping relationship/association rule between the Ms CSI-RS resource subsets and the Nrrh RRHs in the RRH cluster are also possible.

For both Option-1A.1 and Option-1A.2, the UE may be higher layer configured by the network how the CSI-RS resources in the CSI resource set are partitioned into Ms CSI-RS resource subsets. For instance, for Ms=2, the first CSI-RS resource subset could contain the first half of the CSI-RS resources in the CSI resource set, while the second CSI-RS resource subset could contain the second half of the CSI-RS resources in the CSI resource set.

Alternatively, the UE could receive a MAC-CE based activation command indicating how the CSI-RS resources in the CSI resource set are partitioned into Ms CSI-RS resource subsets. For example, a MAC-CE message (such as a bit sequence) can be used for this purpose. The UE could also be indicated via dynamic DCI based triggering how the CSI-RS resources in the CSI resource set are partitioned into Ms CSI-RS resource subsets. For instance, code points of a parameter in the DCI can be used for this purpose.

There are various other configuration/indication methods discussed below: (1) the partition of the CSI-RS resources in the CSI resource set into Ms CSI-RS resource subsets is based on a combination of higher layer (RRC) configuration and MAC CE activation; (2) the partition of the CSI-RS resources in the CSI resource set into Ms CSI-RS resource subsets is based on a combination of higher layer (RRC) configuration and DCI based triggering; (3) the partition of the CSI-RS resources in the CSI resource set into Ms CSI-RS resource subsets is based on a combination of MAC CE activation and DCI based triggering; and/or (4) the partition of the CSI-RS resources in the CSI resource set into Ms CSI-RS resource subsets is based on a combination of higher layer (RRC) configuration, MAC CE activation, and DCI based triggering.

In one example of CSI report setting for Configuration-1A, the UE is higher layer configured with P=1 CSI report setting. The single CSI report setting is associated with all Nrrh RRHs in the RRH cluster configured for the UE. The P=1 CSI report setting can include one CSI report across all RRHs in the RRH cluster or more than one (e.g., one CSI report per RRH in the RRH cluster) CSI reports. A few examples of such reporting contents are provided in the U.S. patent application Ser. No. 17/673,621.

The UE can report all of or a subset of the Nrrh CSI reports dynamically, i.e., the UE could report X Nrrh CSI reports, {CSI(x), x=0, 1, . . . , X−1}, where the value of K could be fixed, or configured to the UE via RRC, or MAC-CE, or DCI, or a combination of at least two of RRC, MAC-CE, and DCI, or autonomously determined by the UE and reported to the network as part of the CSI report and/or a separate CSI parameter and/or jointly with another parameter such as RI, CRI and etc.

If the value of X is chosen dynamically by the UE, the X CSI reports can be partitioned into two parts, CSI part 1 and CSI part 2. In one example, the CSI part 1 and part 2 are as follows: (1) the CSI part 1 includes x₁<X CSI reports, where x₁ is fixed or configured (e.g., x₁=1), and an indication about the remaining x₂=X−x₁ CSI reports. This information can be a bitmap of length Nrrh. The payload (number of bits) of the CSI part 1 is fixed; and/or (2) the CSI part 2 includes the remaining x₂ CSI reports. The payload of the CSI part 2 is variable depending on the value of x₂. In one example, x₂=0 is allowed. In one example, x₂>0.

The two parts of the CSI report can be transmitted (reported) by the UE via a two-part UCI (cf. Rel. 15 two-part UCI). The details about this two-part UCI can be according to the U.S. Patent Application Publication No. 2020/0084006 and U.S. Pat. No. 10,958,326.

In one example of A-CSI trigger state for Configuration-1A, the A-CSI trigger state for Configuration-1A corresponds to one CSI report setting/configuration, which is associated with a cluster of Nrrh RRHs configured for the UE. Further, the CSI report setting is linked to one CSI resource setting comprising of one CSI resource set. In the CSI resource set, the total Ks CSI-RS resources are partitioned into Ms CSI-RS resource subsets, which are associated with the cluster of Nrrh RRHs configured for the UE following Option-1A.1 and/or Option-1A.2.

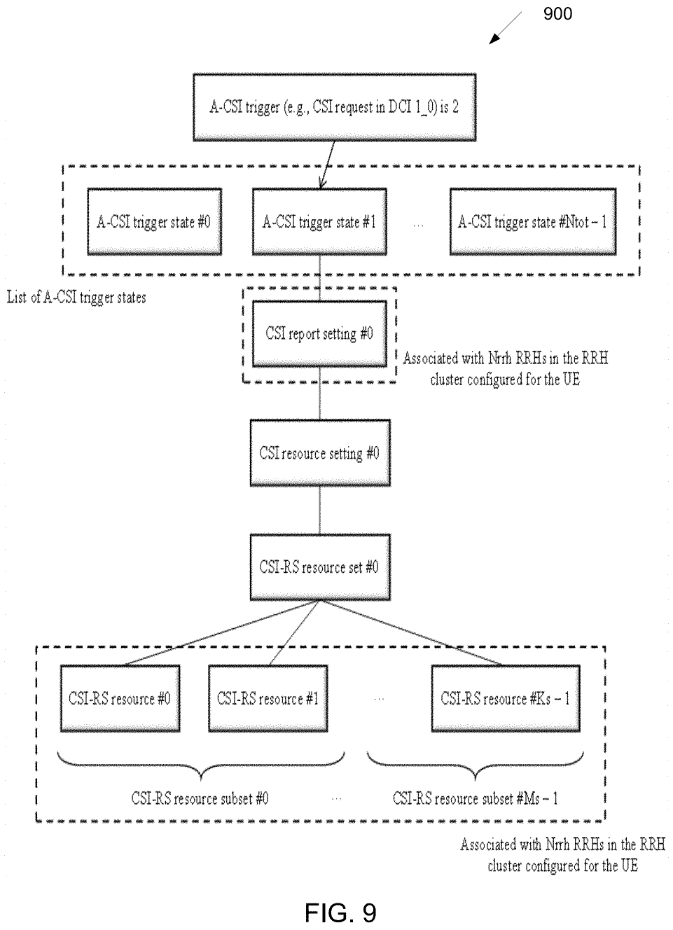

FIG. 9 illustrates an example of an association 900 between an A-CSI trigger state, a CSI reporting setting and one or more CSI resources in a CSI resource set for a distributed RRH system according to embodiments of the present disclosure. An embodiment of the association 900 shown in FIG. 9 is for illustration only.

In FIG. 9, a conceptual example depicting the association between the A-CSI trigger state for Configuration-1A and the CSI report/resource setting, and therefore the associated RRHs, is presented. In this example, the UE first receives from the network an A-CSI trigger (e.g., CSI request in DCI 1_0), whose value is set to 2. The A-CSI trigger value 2 points to the 2^{nd} entry in the list of A-CSI trigger states, which is A-CSI trigger state #1 in this example. The A-CSI trigger state #1 comprises of a single CSI report setting #0, which is associated with all Nrrh RRHs in the RRH cluster for the UE. Further, the CSI report setting #0 is linked to a single CSI resource setting #0 in FIG. 9, which includes a single CSI resource set #0. In the CSI resource set #0, a total of Ks CSI-RS resources are participated into Ms CSI-RS resource subsets, which are associated with all Nrrh RRHs in the RRH cluster for the UE following Option-1A.1 and/or Option-1A.2.

In one example of Configuration-1B, the A-CSI trigger state is associated with one or more CSI-RS resources in one CSI resource set and multiple (more than one) CSI report settings, which are also associated with the RRHs in the RRH cluster configured for the UE.

In one example of CSI resource setting for Configuration-1B, the CSI resource setting for Configuration-1B is the same as that for Configuration-1A. That is, the UE is higher layer configured with M=1 CSI resource setting, and the configured CSI resource setting comprises of S=1 CSI resource set. The Ks≥1 CSI-RS resources configured in the CSI resource set are divided into Ms≥1 CSI-RS resource subsets, which could be labeled as the first CSI-RS resource subset, the second CSI-RS resource subset, and so on, and the Ms-th CSI-RS resource subset; each CSI-RS resource subset, and therefore the CSI-RS resources therein, is associated with a RRH in the RRH cluster for the UE.

A single RRH in the RRH cluster could be associated with a single CSI-RS resource subset, or more than one CSI-RS resource subset, and a single CSI-RS resource subset could be associated with more than one RRH in the RRH cluster. The detailed association rule(s)/mapping relationship(s) between the Ms CSI-RS resource subsets and the Nrrh RRHs in the RRH cluster configured for the UE could follow those discussed in Option-1A.1 and Option-1A.2.

In one example of CSI report setting for Configuration-1B, the UE is higher layer configured with P>1 CSI report settings, which could be regarded/labelled as the first CSI report setting, the second CSI report setting, and so on, and the P-th CSI report setting. Each CSI report setting could be associated with one or more RRHs in the RRH cluster configured for the UE. If P<Nrrh, a single CSI report setting could be associated with more than one RRH in the RRH cluster. If P=Nrrh, a single RRH in the RRH cluster could be associated with a single CSI report setting. If P>Nrrh, a single RRH in the RRH cluster could be associated with more than one CSI report setting.

In one example of Option-1B.1, the mapping/association between the P CSI resource settings and the Nrrh RRHs in the RRH cluster configured for the UE can be established in an implicit manner. For instance, for P=Nrrh, the first CSI report setting could be associated with the first RRH, the second CSI report setting could be associated with the second RRH, and so on, and the P-th CSI report setting could be associated with the last RRH. In one example, the first RRH could correspond to the first RRH in a list of RRHs configured to the UE, the second RRH could correspond to the second RRH in the list of RRHs configured to the UE, and so on, and the last RRH could correspond to the last RRH in the list of RRHs configured to the UE. In another example, the first RRH could correspond to the RRH with the lowest RRH ID value, the second RRH could correspond to the RRH with the second lowest RRH ID value, and so on, and the last RRH could correspond to the RRH with the highest RRH ID value. Other implicit mapping/association rules between the P CSI report settings and the Nrrh RRHs in the RRH cluster are also possible, and they may be known to the UE a prior.

In one example of Option-1B.2, the UE could be explicitly indicated by the network the mapping relationship/association rule between the P CSI report settings and the Nrrh RRHs in the RRH cluster configured for the UE. This indication could be via higher layer (RRC) or/and MAC CE or/and DCI based signaling. In one example, this indication is via a separate (dedicated) parameter or joint with another parameter. Likewise, this indication could be together with the CSI reporting settings (e.g., in the higher layer parameter CSI-reportConfig) or together with the CSI resource settings (e.g., in the higher layer parameter CSI-resourceConfig) or together with the CSI request field triggering the CSI reporting.

Further, this indication could also be together with the indication of RRH clustering and/or RRH grouping. In one example, the UE could be configured by the network a RRH ID list containing Nrrh RRH IDs or RRH-specific higher layer signaling indices. For instance, for P=Nrrh, the first CSI report setting could be associated with the first entry (and therefore, the corresponding RRH ID/RRH-specific higher layer signaling index) in the RRH ID list, the second CSI report setting could be associated with the second entry (and therefore, the corresponding RRH ID/RRH-specific higher layer signaling index) in the RRH ID list, and so on, and the P-th CSI report setting could be associated with the last entry (and therefore, the corresponding RRH ID/RRH-specific higher layer signaling index) in the RRH ID list. Other explicit methods of indicating the mapping relationship/association rule between the P CSI report settings and the Nrrh RRHs in the RRH cluster are also possible.

The UE can report all of or a subset of the P CSI reports dynamically (here, each CSI report is associated with a separate CSI report setting), i.e., the UE could report Y≤P CSI reports, {CSI(y), y=0, 1, . . . , Y−1}, where the value of Y could be fixed, or configured to the UE via RRC, or MAC-CE, or DCI, or a combination of at least two of RRC, MAC-CE, and DCI, or autonomously determined by the UE and reported to the network as part of the CSI report and/or a separate CSI parameter and/or jointly with another parameter such as RI, CRI and etc.

If the value of Y is chosen dynamically by the UE, the Y CSI reports can be partitioned into two parts, CSI part 1 and CSI part 2. In one example, the CSI part 1 and part 2 are as follows: (1) the CSI part 1 includes y₁<Y CSI reports, where y₁ is fixed or configured (e.g., y₁=1), and an indication about the remaining y₂=Y−y₁ CSI reports. This information can be a bitmap of length P. The payload (number of bits) of the CSI part 1 is fixed; and/or (2) the CSI part 2 includes the remaining y₂ CSI reports. The payload of the CSI part 2 is variable depending on the value of y₂. In one example, y₂=0 is allowed. In one example, y₂>0.

The two parts of the CSI report can be transmitted (reported) by the UE via a two-part UCI (cf. Rel. 15 two-part UCI).

In one example of A-CSI trigger state for Configuration-1B, the A-CSI trigger state for Configuration-1B corresponds to P>1 CSI report settings/configurations, which are associated with a cluster of Nrrh RRHs configured for the UE following Option-1B.1 and/or Option-1B.2. Further, the P CSI report settings are linked to one CSI resource setting comprising of one CSI resource set. In the CSI resource set, the total Ks CSI-RS resources are partitioned into Ms CSI-RS resource subsets, which are associated with the cluster of Nrrh RRHs configured for the UE following Option-1A.1 and/or Option-1A.2. From the above discussions, if the CSI-RS resource subset(s) and the CSI report setting(s) are associated with the same RRH(s), they are implicitly linked to each other.

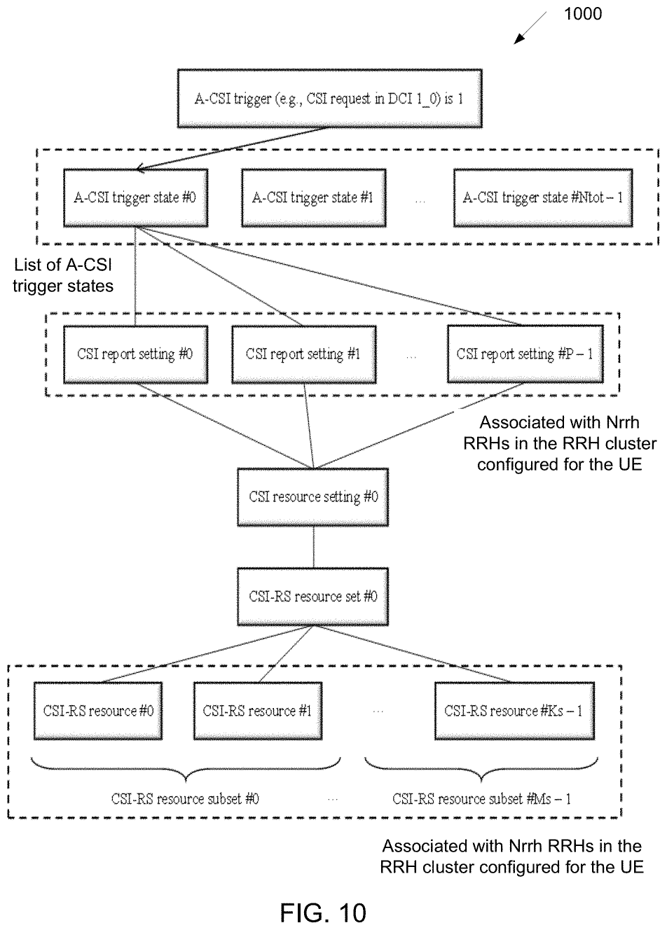

FIG. 10 illustrates an example of an association 1000 between an A-CSI trigger state, one or more CSI reporting settings and one or more CSI resources in a CSI resource set for a distributed RRH system according to embodiments of the present disclosure. An embodiment of the association 1000 shown in FIG. 10 is for illustration only.

In FIG. 10, a conceptual example depicting the association between the A-CSI trigger state for Configuration-1B and the CSI report/resource setting, and therefore the associated RRHs, is presented. In this example, the UE first receives from the network an A-CSI trigger (e.g., CSI request in DCI 1_0), whose value is set to 1. The A-CSI trigger value 1 points to the 1^{st} entry in the list of A-CSI trigger states, which is A-CSI trigger state #0 in this example. The A-CSI trigger state #0 comprises of P>1 CSI report settings #0, #1, . . . , #P−1, which are associated with all Nrrh RRHs in the RRH cluster for the UE following Option-1B.1 and/or Option-1B.2.

Further, the CSI report settings #0, #1, . . . , #P−1 are linked to a single CSI resource setting #0 in FIG. 10, which includes a single CSI resource set #0. In the CSI resource set #0, a total of Ks CSI-RS resources are participated into Ms CSI-RS resource subsets, which are associated with all Nrrh RRHs in the RRH cluster for the UE following Option-1A.1 and/or Option-1A.2.

In one example of Configuration-2A, the A-CSI trigger state is associated with multiple (more than one) CSI resource sets in one CSI resource setting and one CSI report setting, which are also associated with the RRHs in the RRH cluster configured for the UE.

In one example of CSI resource setting for Configuration-2A, the UE is higher layer configured with M=1 CSI resource setting, and the configured CSI resource setting comprises of S>1 CSI resource sets, which could be regarded/labeled as the first CSI resource set, the second CSI resource set, and so on, and the S-th CSI resource set; each CSI resource set, and therefore the CSI-RS resources therein, could be associated with one or more RRHs in the RRH cluster for the UE. A single RRH in the RRH cluster could be associated with a single CSI resource set. Further, for S>Nrrh, a single RRH in the RRH cluster could be associated with more than one CSI resource set. In addition, for S<Nrrh, a single CSI resource set could be associated with more than one RRH in the RRH cluster.

In one example of Option-2A.1, the mapping/association between the S CSI resource sets and the Nrrh RRHs in the RRH cluster configured for the UE can be established in an implicit manner. For instance, for S=Nrrh, the first CSI resource set containing one or more CSI-RS resources could be associated with the first RRH, the second CSI resource set containing one or more CSI-RS resources could be associated with the second RRH, and so on, and the S-th CSI resource set containing one or more CSI-RS resources could be associated with the last RRH. In one example, the first RRH could correspond to the first RRH in a list of RRHs configured to the UE, the second RRH could correspond to the second RRH in the list of RRHs configured to the UE, and so on, and the last RRH could correspond to the last RRH in the list of RRHs configured to the UE.

In another example, the first RRH could correspond to the RRH with the lowest RRH ID value, the second RRH could correspond to the RRH with the second lowest RRH ID value, and so on, and the last RRH could correspond to the RRH with the highest RRH ID value. Other implicit mapping/association rules between the S CSI resource sets and the Nrrh RRHs in the RRH cluster are also possible, and they may be known to the UE a prior.

In one example of Option-2A.2, the UE could be explicitly indicated by the network the mapping relationship/association rule between the S CSI resource sets (and therefore, the corresponding CSI-RS resources therein) and the Nrrh RRHs in the RRH cluster configured for the UE. This indication could be via higher layer (RRC) or/and MAC CE or/and DCI based signaling. In one example, this indication is via a separate (dedicated) parameter or joint with another parameter. Likewise, this indication could be together with the CSI reporting settings (e.g., in the higher layer parameter CSI-reportConfig) or together with the CSI resource settings (e.g., in the higher layer parameter CSI-resourceConfig) or together with the CSI request field triggering the CSI reporting.

Further, this indication could also be together with the indication of RRH clustering and/or RRH grouping. In one example, the UE could be configured by the network a RRH ID list containing Nrrh RRH IDs or RRH-specific higher layer signaling indices. For instance, for S=Nrrh, the first CSI resource set containing one or more CSI-RS resources could be associated with the first entry (and therefore, the corresponding RRH ID/RRH-specific higher layer signaling index) in the RRH ID list, the second CSI resource set containing one or more CSI-RS resources could be associated with the second entry (and therefore, the corresponding RRH ID/RRH-specific higher layer signaling index) in the RRH ID list, and so on, and the S-th CSI resource set containing one or more CSI-RS resources could be associated with the last entry (and therefore, the corresponding RRH ID/RRH-specific higher layer signaling index) in the RRH ID list. Other explicit methods of indicating the mapping relationship/association rule between the S CSI resource sets and the Nrrh RRHs in the RRH cluster are also possible.

In one example of CSI report setting for Configuration-2A, the UE is higher layer configured with P=1 CSI report setting. The single CSI report setting is associated with all Nrrh RRHs in the RRH cluster configured for the UE. The P=1 CSI report setting can include one CSI report across all RRHs in the RRH cluster or more than one (e.g., one CSI report per RRH in the RRH cluster) CSI reports. A few examples of such reporting contents are provided in the U.S. patent application Ser. No. 17/673,621.

The UE can report all of or a subset of the Nrrh CSI reports dynamically, i.e., the UE could report X Nrrh CSI reports, {CSI(x), x=0, 1, . . . , X−1}, where the value of K could be fixed, or configured to the UE via RRC, or MAC-CE, or DCI, or a combination of at least two of RRC, MAC-CE, and DCI, or autonomously determined by the UE and reported to the network as part of the CSI report and/or a separate CSI parameter and/or jointly with another parameter such as RI, CRI and etc.

If the value of X is chosen dynamically by the UE, the X CSI reports can be partitioned into two parts, CSI part 1 and CSI part 2. In one example, the CSI part 1 and part 2 are as follows: (1) the CSI part 1 includes x₁<X CSI reports, where x₁ is fixed or configured (e.g., x₁=1), and an indication about the remaining x₂=X−x₁ CSI reports. This information can be a bitmap of length Nrrh. The payload (number of bits) of the CSI part 1 is fixed; and/or (2) the CSI part 2 includes the remaining x₂ CSI reports. The payload of the CSI part 2 is variable depending on the value of x₂. In one example, x₂=0 is allowed. In one example, x₂>0.

The two parts of the CSI report can be transmitted (reported) by the UE via a two-part UCI (cf. Rel. 15 two-part UCI). The details about this two-part UCI can be according to the U.S. Patent Application Publication No. 2020/0084006 and U.S. Pat. No. 10,958,326.

In one example of A-CSI trigger state for Configuration-2A, the A-CSI trigger state for Configuration-2A corresponds to one CSI report setting/configuration, which is associated with a cluster of Nrrh RRHs configured for the UE. Further, the CSI report setting is linked to one CSI resource setting comprising of S>1 CSI resource sets, which are associated with the cluster of Nrrh RRHs configured for the UE following Option-2A.1 and/or Option-2A.2.

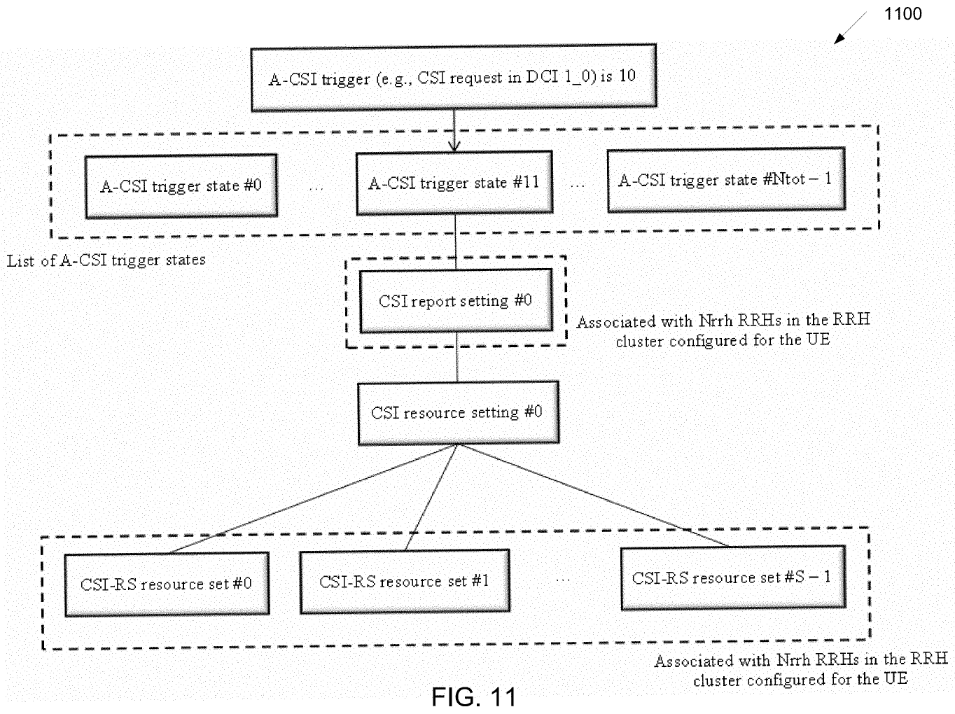

FIG. 11 illustrates an example of an association 1100 between an A-CSI trigger state, a CSI reporting setting and one or more CSI resource sets in a CSI resource setting for a distributed RRH system according to embodiments of the present disclosure. An embodiment of the association 1100 shown in FIG. 11 is for illustration only.

In FIG. 11, a conceptual example depicting the association between the A-CSI trigger state for Configuration-2A and the CSI report/resource setting, and therefore the associated RRHs, is presented. In this example, the UE first receives from the network an A-CSI trigger (e.g., CSI request in DCI 1_0), whose value is set to 10. The A-CSI trigger value 10 points to the 10^{th} entry in the list of A-CSI trigger states, which is A-CSI trigger state #11 in this example. The A-CSI trigger state #11 comprises of a single CSI report setting #0, which is associated with all Nrrh RRHs in the RRH cluster for the UE. Further, the CSI report setting #0 is linked to a single CSI resource setting #0 in FIG. 11, which includes S>1 CSI resource sets #0, #1, . . . , #S−1, which are associated with all Nrrh RRHs in the RRH cluster for the UE following Option-2A.1 and/or Option-2A.2.

In one example of Configuration-2B, the A-CSI trigger state is associated with multiple (more than one) CSI resource sets in one CSI resource setting and multiple (more than one) CSI report settings, which are also associated with the RRHs in the RRH cluster configured for the UE.

In one example of CSI resource setting for Configuration-2B, the CSI resource setting for Configuration-2B is the same as that for Configuration-2A. That is, the UE is higher layer configured with M=1 CSI resource setting, and the configured CSI resource setting comprises of S>1 CSI resource sets, which could be regarded/labeled as the first CSI resource set, the second CSI resource set, and so on, and the S-th CSI resource set; each CSI resource set, and therefore the CSI-RS resources therein, could be associated with one or more RRHs in the RRH cluster for the UE. A single RRH in the RRH cluster could be associated with a single CSI resource set, or more than one CSI resource set, and a single CSI resource set could be associated with more than one RRH in the RRH cluster. The detailed association rule(s)/mapping relationship(s) between the S CSI resource sets and the Nrrh RRHs in the RRH cluster configured for the UE could follow those discussed in Option-2A.1 and Option-2A.2.

In one example of CSI report setting for Configuration-2B, the CSI report setting for Configuration-2B is the same as that for Configuration-1B. That is, the UE is higher layer configured with P>1 CSI report settings, which could be regarded/labelled as the first CSI report setting, the second CSI report setting, and so on, and the P-th CSI report setting. Each CSI report setting could be associated with one or more RRHs in the RRH cluster configured for the UE. A single CSI report setting could be associated with more than one RRH in the RRH cluster, and a single RRH in the RRH cluster could be associated with a single CSI report setting or more than one CSI report setting. The detailed association rule(s)/mapping relationship(s) between the P CSI resource settings and the Nrrh RRHs in the RRH cluster configured for the UE could follow those discussed in Option-1B.1 and Option-1B.2.

The UE can report all of or a subset of the P CSI reports dynamically (here, each CSI report is associated with a separate CSI report setting), i.e., the UE could report Y≤P CSI reports, {CSI(y), y=0, 1, . . . , Y−1}, where the value of Y could be fixed, or configured to the UE via RRC, or MAC-CE, or DCI, or a combination of at least two of RRC, MAC-CE, and DCI, or autonomously determined by the UE and reported to the network as part of the CSI report and/or a separate CSI parameter and/or jointly with another parameter such as RI, CRI and etc.

If the value of Y is chosen dynamically by the UE, the Y CSI reports can be partitioned into two parts, CSI part 1 and CSI part 2. In one example, the CSI part 1 and part 2 are as follows: (1) the CSI part 1 includes y₁<Y CSI reports, where y₁ is fixed or configured (e.g., y₁=1), and an indication about the remaining y₂=Y−y₁ CSI reports. This information can be a bitmap of length P. The payload (number of bits) of the CSI part 1 is fixed; and/or (2) the CSI part 2 includes the remaining y₂ CSI reports. The payload of the CSI part 2 is variable depending on the value of y₂. In one example, y₂=0 is allowed. In one example, y₂>0.

The two parts of the CSI report can be transmitted (reported) by the UE via a two-part UCI (cf. Rel. 15 two-part UCI).

In one example of A-CSI trigger state for Configuration-2B, the A-CSI trigger state for Configuration-2B corresponds to P>1 CSI report settings/configurations, which are associated with a cluster of Nrrh RRHs configured for the UE following Option-1B.1 and/or Option-1B.2. Further, the P CSI report settings are linked to one CSI resource setting comprising of S>1 CSI resource sets, which are associated with the cluster of Nrrh RRHs configured for the UE following Option-2A.1 and/or Option-2A.2. From the above discussions, if the CSI resource set(s) and the CSI report setting(s) are associated with the same RRH(s), they are implicitly linked to each other.

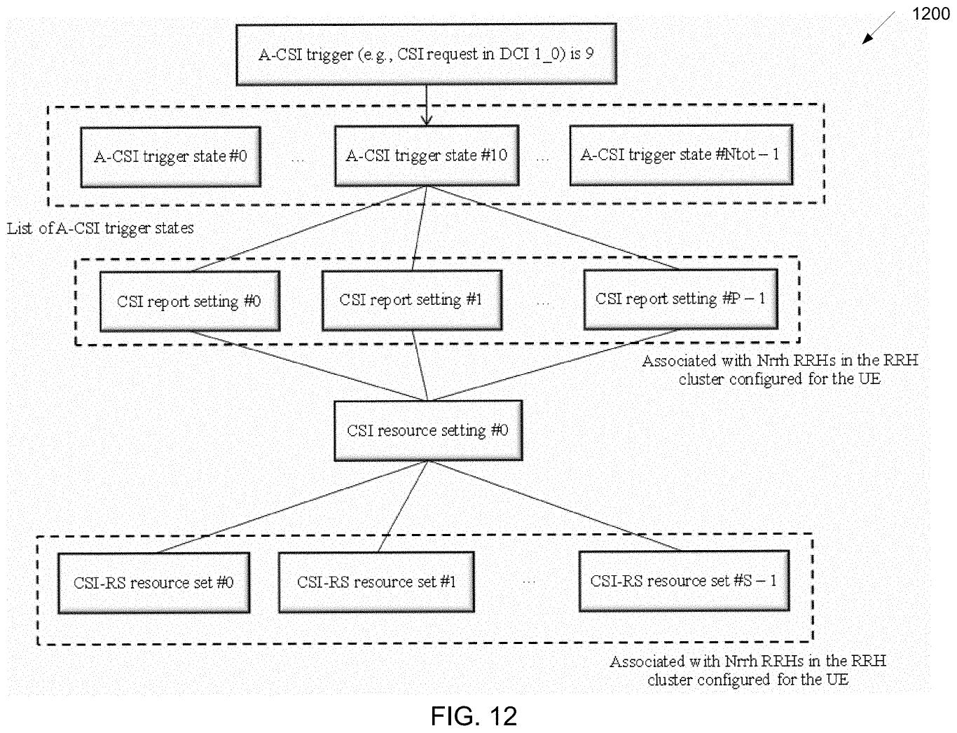

FIG. 12 illustrates an example of an association 1200 between an A-CSI trigger state, one or more CSI reporting settings and one or more CSI resource sets in a CSI resource setting for a distributed RRH system according to embodiments of the present disclosure. An embodiment of the association 1200 shown in FIG. 12 is for illustration only.

In FIG. 12, a conceptual example depicting the association between the A-CSI trigger state for Configuration-2B and the CSI report/resource setting, and therefore the associated RRHs, is presented. In this example, the UE first receives from the network an A-CSI trigger (e.g., CSI request in DCI 1_0), whose value is set to 9. The A-CSI trigger value 9 points to the 9^{th} entry in the list of A-CSI trigger states, which is A-CSI trigger state #10 in this example. The A-CSI trigger state #10 comprises of P>1 single CSI report settings #0, #1, . . . , #P−1, which are associated with all Nrrh RRHs in the RRH cluster for the UE following Option-1B.1 and/or Option-1B.2. Further, the CSI report settings #0, #1, . . . , #P−1 are linked to a single CSI resource setting #0 in FIG. 12, which includes S>1 CSI resource sets #0, #1, . . . , #S−1, which are associated with all Nrrh RRHs in the RRH cluster for the UE following Option-2A.1 and/or Option-2A.2.

In one example of Configuration-3A, the A-CSI trigger state is associated with multiple (more than one) CSI resource settings and one CSI report setting, which are also associated with the RRHs in the RRH cluster configured for the UE.

In one example of CSI resource setting for Configuration-3A, the UE is higher layer configured with M>1 CSI resource settings, which could be regarded/labeled as the first CSI resource setting, the second CSI resource setting, and so on, and the M-th CSI resource setting; each CSI resource setting, and therefore the CSI-RS resources therein, could be associated with one or more RRHs in the RRH cluster for the UE. A single RRH in the RRH cluster could be associated with a single CSI resource setting. Further, for M>Nrrh, a single RRH in the RRH cluster could be associated with more than one CSI resource settings. In addition, for M<Nrrh, a single CSI resource setting could be associated with more than one RRH in the RRH cluster.

In one example of Option-3A.1, the mapping/association between the M CSI resource settings and the Nrrh RRHs in the RRH cluster configured for the UE can be established in an implicit manner. For instance, for M=Nrrh, the first CSI resource setting containing one or more CSI resource sets could be associated with the first RRH, the second CSI resource setting containing one or more CSI resource sets could be associated with the second RRH, and so on, and the M-th CSI resource setting containing one or more CSI resource sets could be associated with the last RRH.

In one example, the first RRH could correspond to the first RRH in a list of RRHs configured to the UE, the second RRH could correspond to the second RRH in the list of RRHs configured to the UE, and so on, and the last RRH could correspond to the last RRH in the list of RRHs configured to the UE.

In another example, the first RRH could correspond to the RRH with the lowest RRH ID value, the second RRH could correspond to the RRH with the second lowest RRH ID value, and so on, and the last RRH could correspond to the RRH with the highest RRH ID value. Other implicit mapping/association rules between the M CSI resource settings and the Nrrh RRHs in the RRH cluster are also possible, and they may be known to the UE a prior.

In one example of Option-3A.2, the UE could be explicitly indicated by the network the mapping relationship/association rule between the M CSI resource settings (and therefore, the corresponding CSI-RS resources therein) and the Nrrh RRHs in the RRH cluster configured for the UE. This indication could be via higher layer (RRC) or/and MAC CE or/and DCI based signaling. In one example, this indication is via a separate (dedicated) parameter or joint with another parameter. Likewise, this indication could be together with the CSI reporting settings (e.g., in the higher layer parameter CSI-reportConfig) or together with the CSI resource settings (e.g., in the higher layer parameter CSI-resourceConfig) or together with the CSI request field triggering the CSI reporting.

Further, this indication could also be together with the indication of RRH clustering and/or RRH grouping. In one example, the UE could be configured by the network a RRH ID list containing Nrrh RRH IDs or RRH-specific higher layer signaling indices. For instance, for M=Nrrh, the first CSI resource setting containing one or more CSI resource sets could be associated with the first entry (and therefore, the corresponding RRH ID/RRH-specific higher layer signaling index) in the RRH ID list, the second CSI resource setting containing one or more CSI resource sets could be associated with the second entry (and therefore, the corresponding RRH ID/RRH-specific higher layer signaling index) in the RRH ID list, and so on, and the M-th CSI resource setting containing one or more CSI resource sets could be associated with the last entry (and therefore, the corresponding RRH ID/RRH-specific higher layer signaling index) in the RRH ID list. Other explicit methods of indicating the mapping relationship/association rule between the M CSI resource settings and the Nrrh RRHs in the RRH cluster are also possible.

In one example of CSI report setting for Configuration-3A, the UE is higher layer configured with P=1 CSI report setting. The single CSI report setting is associated with all Nrrh RRHs in the RRH cluster configured for the UE. The P=1 CSI report setting can include one CSI report across all RRHs in the RRH cluster or more than one (e.g., one CSI report per RRH in the RRH cluster) CSI reports. A few examples of such reporting contents are provided in the U.S. patent application Ser. No. 17/673,621.

The UE can report all of or a subset of the Nrrh CSI reports dynamically, i.e., the UE could report X Nrrh CSI reports, {CSI(x), x=0, 1, . . . , X−1}, where the value of K could be fixed, or configured to the UE via RRC, or MAC-CE, or DCI, or a combination of at least two of RRC, MAC-CE, and DCI, or autonomously determined by the UE and reported to the network as part of the CSI report and/or a separate CSI parameter and/or jointly with another parameter such as RI, CRI and etc.

If the value of X is chosen dynamically by the UE, the X CSI reports can be partitioned into two parts, CSI part 1 and CSI part 2. In one example, the CSI part 1 and part 2 are as follows: (1) the CSI part 1 includes x₁<X CSI reports, where x₁ is fixed or configured (e.g., x₁=1), and an indication about the remaining x₂=X−x₁ CSI reports. This information can be a bitmap of length Nrrh. The payload (number of bits) of the CSI part 1 is fixed; and/or (2) the CSI part 2 includes the remaining x₂ CSI reports. The payload of the CSI part 2 is variable depending on the value of x₂. In one example, x₂=0 is allowed. In one example, x₂>0.

The two parts of the CSI report can be transmitted (reported) by the UE via a two-part UCI (cf. Rel. 15 two-part UCI). The details about this two-part UCI can be according to the U.S. Patent Application Publication No. 2020/0084006 and U.S. Pat. No. 10,958,326.

In one example of A-CSI trigger state for Configuration-3A, the A-CSI trigger state for Configuration-3A corresponds to one CSI report setting/configuration, which is associated with a cluster of Nrrh RRHs configured for the UE. Further, the CSI report setting is linked to M>1 CSI resource settings, which are associated with the cluster of Nrrh RRHs configured for the UE following Option-3A.1 and/or Option-3A.2.

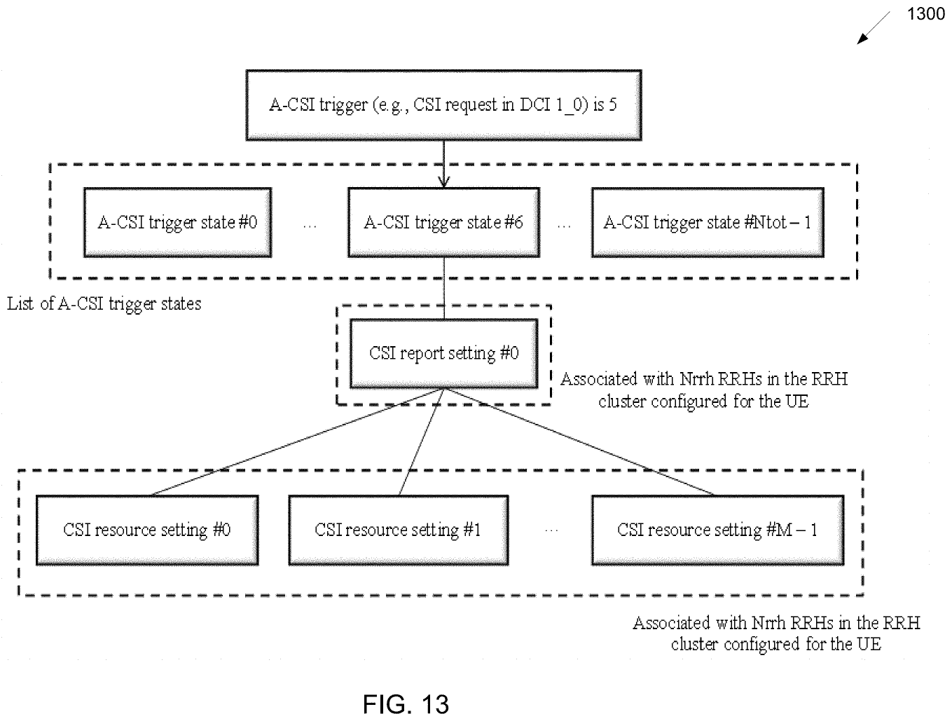

FIG. 13 illustrates an example of an association 1300 between an A-CSI trigger state, a CSI reporting setting and one or more CSI resource settings for a distributed RRH system according to embodiments of the present disclosure. An embodiment of the association 1300 shown in FIG. 13 is for illustration only.

In FIG. 13, a conceptual example depicting the association between the A-CSI trigger state for Configuration-3A and the CSI report/resource setting, and therefore the associated RRHs, is presented. In this example, the UE first receives from the network an A-CSI trigger (e.g., CSI request in DCI 1_0), whose value is set to 5. The A-CSI trigger value 5 points to the 5^{th} entry in the list of A-CSI trigger states, which is A-CSI trigger state #6 in this example. The A-CSI trigger state #6 comprises of a single CSI report setting #0, which is associated with all Nrrh RRHs in the RRH cluster for the UE. Further, the CSI report setting #0 is linked to M>1 CSI resource settings #0, #1, . . . , #M−1 in FIG. 13, which are associated with all Nrrh RRHs in the RRH cluster for the UE following Option-3A.1 and/or Option-3A.2.

In one example of Configuration-3B, the A-CSI trigger state is associated with multiple (more than one) CSI resource settings and multiple (more than one) CSI report settings, which are also associated with the RRHs in the RRH cluster configured for the UE.

In one example of CSI resource setting for Configuration-3B, the CSI resource setting for Configuration-3B is the same as that for Configuration-3A. That is, the UE is higher layer configured with M>1 CSI resource settings, which could be regarded/labeled as the first CSI resource setting, the second CSI resource setting, and so on, and the M-th CSI resource setting; each CSI resource setting, and therefore the CSI-RS resources therein, could be associated with one or more RRHs in the RRH cluster for the UE. A single RRH in the RRH cluster could be associated with a single CSI resource setting, or more than one CSI resource settings, and a single CSI resource setting could be associated with more than one RRH in the RRH cluster. The detailed association rule(s)/mapping relationship(s) between the M CSI resource settings and the Nrrh RRHs in the RRH cluster configured for the UE could follow those discussed in Option-3A.1 and Option-3A.2.

In one example of CSI report setting for Configuration-3B, the CSI report setting for Configuration-3B is the same as that for Configuration-1B. That is, the UE is higher layer configured with P>1 CSI report settings, which could be regarded/labelled as the first CSI report setting, the second CSI report setting, and so on, and the P-th CSI report setting. Each CSI report setting could be associated with one or more RRHs in the RRH cluster configured for the UE. A single CSI report setting could be associated with more than one RRH in the RRH cluster, and a single RRH in the RRH cluster could be associated with a single CSI report setting or more than one CSI report setting. The detailed association rule(s)/mapping relationship(s) between the P CSI resource settings and the Nrrh RRHs in the RRH cluster configured for the UE could follow those discussed in Option-1B.1 and Option-1B.2.

The UE can report all of or a subset of the P CSI reports dynamically (here, each CSI report is associated with a separate CSI report setting), i.e., the UE could report Y≤P CSI reports, {CSI(y), y=0, 1, . . . , Y−1}, where the value of Y could be fixed, or configured to the UE via RRC, or MAC-CE, or DCI, or a combination of at least two of RRC, MAC-CE, and DCI, or autonomously determined by the UE and reported to the network as part of the CSI report and/or a separate CSI parameter and/or jointly with another parameter such as RI, CRI and etc.

If the value of Y is chosen dynamically by the UE, the Y CSI reports can be partitioned into two parts, CSI part 1 and CSI part 2. In one example, the CSI part 1 and part 2 are as follows: (1) the CSI part 1 includes y₁<Y CSI reports, where y₁ is fixed or configured (e.g., y₁=1), and an indication about the remaining y₂=Y−y₁ CSI reports. This information can be a bitmap of length P. The payload (number of bits) of the CSI part 1 is fixed; and/or (2) the CSI part 2 includes the remaining y₂ CSI reports. The payload of the CSI part 2 is variable depending on the value of y₂. In one example, y₂=0 is allowed. In one example, y₂>0.

The two parts of the CSI report can be transmitted (reported) by the UE via a two-part UCI (cf. Rel. 15 two-part UCI).

In one example of A-CSI trigger state for Configuration-3B, the A-CSI trigger state for Configuration-3B corresponds to P>1 CSI report settings/configurations, which are associated with a cluster of Nrrh RRHs configured for the UE following Option-1B.1 and/or Option-1B.2. Further, the P CSI report settings are linked to S>1 CSI resource settings, which are associated with the cluster of Nrrh RRHs configured for the UE following Option-2A.1 and/or Option-2A.2. From the above discussions, if the CSI resource setting(s) and the CSI report setting(s) are associated with the same RRH(s), they are implicitly linked to each other.

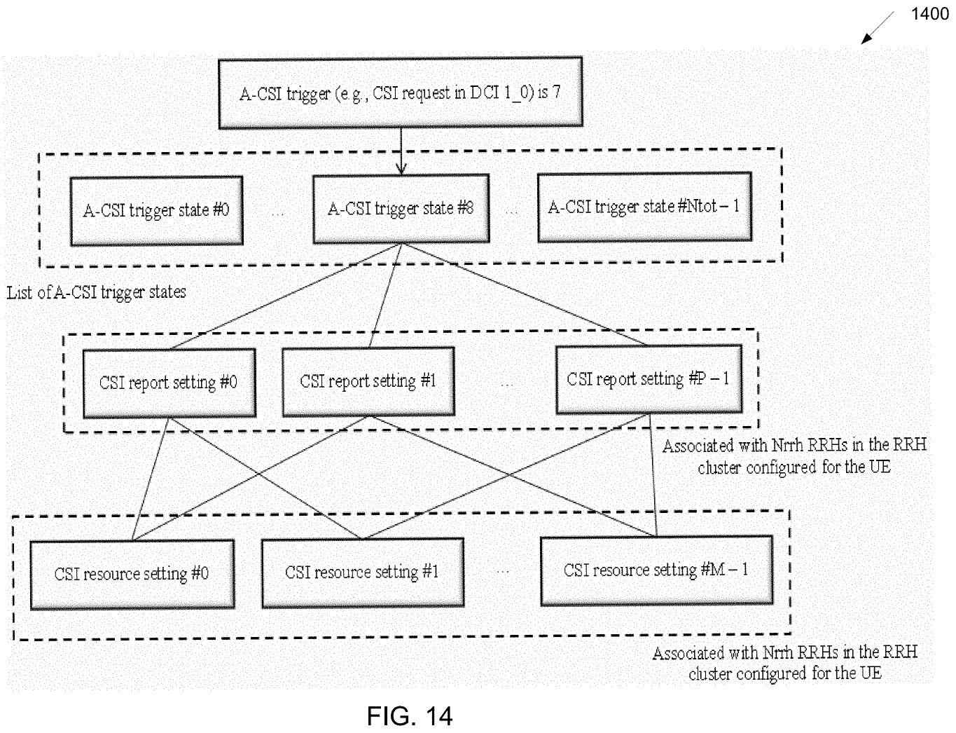

FIG. 14 illustrates an example of an association 1400 between an A-CSI trigger state, one or more CSI reporting settings and one or more CSI resource settings for a distributed RRH system according to embodiments of the present disclosure. An embodiment of the association 1400 shown in FIG. 14 is for illustration only.

In FIG. 14, a conceptual example depicting the association between the A-CSI trigger state for Configuration-3B and the CSI report/resource setting, and therefore the associated RRHs, is presented. In this example, the UE first receives from the network an A-CSI trigger (e.g., CSI request in DCI 1_0), whose value is set to 7. The A-CSI trigger value 7 points to the 7^{th} entry in the list of A-CSI trigger states, which is A-CSI trigger state #8 in this example. The A-CSI trigger state #8 comprises of P>1 CSI report settings #0, #1, . . . , #P−1, which are associated with all Nrrh RRHs in the RRH cluster for the UE following Option-1B.1 and/or Option-1B.2.

Further, the CSI report settings #0, #1, . . . , #P−1 are linked to M>1 CSI resource settings #0, #1, . . . , #M−1 in FIG. 14, which are associated with all Nrrh RRHs in the RRH cluster for the UE following Option-3A.1 and/or Option-3A.2. As can be seen from FIG. 14, one CSI report setting could be linked to more than one CSI resource setting, and one CSI resource setting could be linked to more than one CSI report setting. The CSI resource setting(s) and CSI report setting(s) are linked to each other if they are associated with the same RRH(s).

In the following description, an RRH can represent a collection of measurement antenna ports or measurement RS resources. For example, an RRH can be associated with a plurality of CSI-RS resources or CRIs (CSI-RS resource indices/indicators). Optionally, an RRH can be associated with a measurement RS resource set—or, for example, CSI resource set along with its indicator.

The term “RRH group” can represent a cluster of RRHs and, hence, a group of collections of measurement RS resources or a group of measurement RS resource sets.

As discussed above, the UE could communicate with Ng≥1 groups of RRHs (or RRH groups) in the RRH cluster configured for the UE. A RRH group could contain one or more RRHs.

In one example of a single A-CSI trigger for all Ng RRH groups, the UE receives from the network a single A-CSI trigger (e.g., a single CSI request in DCI format 1_0), which points to a single A-CSI trigger state in the list of A-CSI trigger states. The A-CSI trigger state could be associated with various CSI resource/report settings/configurations, which are also associated with the RRH groups in the RRH cluster configured for the UE.

In one example of a single A-CSI trigger for all Ng RRH groups, a RRH group could be regarded as a RRH in the design configurations (Configuration-1A, Configuration-1B, Configuration-2A, Configuration-2B, Configuration-3A and Configuration-3B) discussed above. That is, the definition of the A-CSI trigger state and how it is associated with various CSI resource/report settings/configurations for all Ng RRH groups in the RRH cluster follow those described in Configuration-1A, Configuration-1B, Configuration-2A, Configuration-2B, Configuration-3A and/or Configuration-3B by regarding a RRH group as a RRH in these design options.

In such example, the A-CSI trigger state is associated with one or more CSI-RS resources in one CSI resource set and one CSI report setting, which are also associated with the Ng RRH groups in the RRH cluster configured for the UE.

In such example, the A-CSI trigger state is associated with one or more CSI-RS resources in one CSI resource set and multiple (more than one) CSI report settings, which are also associated with the Ng RRH groups in the RRH cluster configured for the UE.

In such example, the A-CSI trigger state is associated with multiple (more than one) CSI resource sets in one CSI resource setting and one CSI report setting, which are also associated with the Ng RRH groups in the RRH cluster configured for the UE.

In such example, the A-CSI trigger state is associated with multiple (more than one) CSI resource sets in one CSI resource setting and multiple (more than one) CSI report settings, which are also associated with the Ng RRH groups in the RRH cluster configured for the UE.

In such example, the A-CSI trigger state is associated with multiple (more than one) CSI resource settings and one CSI report setting, which are also associated with the Ng RRH groups in the RRH cluster configured for the UE.

In such example, the A-CSI trigger state is associated with multiple (more than one) CSI resource settings and multiple (more than one) CSI report settings, which are also associated with the Ng RRH groups in the RRH cluster configured for the UE.

In one example of a separate A-CSI triggers for all Ng RRH groups, the UE receives from the network Mg>1 separate A-CSI triggers, which point to Mg>1 separate A-CSI trigger states in the list of A-CSI trigger states. Each A-CSI trigger state could be associated with various CSI resource/report settings/configurations, which are also associated with one or more RRH groups in the RRH cluster configured for the UE. For Mg>Ng, an A-CSI trigger state could be associated with multiple (more than one) RRH groups; in this case, the association between the A-CSI trigger state and the RRH groups could follow those discussed in Configuration-1A, Configuration-1B, Configuration-2A, Configuration-2B, Configuration-3A and/or Configuration-3B by regarding a RRH group as a RRH in these design options. An A-CSI trigger state could also be associated with a single RRH group; in this case, the association between the A-CSI trigger state and the RRHs in the RRH group could follow those discussed in Configuration-1A, Configuration-1B, Configuration-2A, Configuration-2B, Configuration-3A and/or Configuration-3B.

In one example of a separate A-CSI triggers for all Ng RRH groups, the UE could receive multiple A-CSI triggers in a single DCI, e.g., multiple CSI request fields in a single DCI. The UE could implicitly know the mapping relationship(s)/association rule(s) between the A-CSI triggers in the DCI and the RRH groups. In one example, the first A-CSI trigger in the set of A-CSI triggers in the DCI could correspond to the first RRH group in a list of RRH groups configured to the UE, the second A-CSI trigger in the set of A-CSI triggers in the DCI could correspond to the second RRH group in the list of RRH groups configured to the UE, and so on. In another example, the first A-CSI trigger in the set of A-CSI triggers in the DCI could correspond to the RRH group with the lowest RRH group ID/RRH group-specific higher layer signaling index, the second A-CSI trigger in the set of A-CSI triggers in the DCI could correspond to the RRH group with the second lowest RRH group ID/RRH group-specific higher layer signaling index, and so on, and the last A-CSI trigger in the set of A-CSI triggers in the DCI could correspond to the RRH group with the highest RRH group ID/RRH group-specific higher layer signaling index. Other implicit mapping relationship(s)/association rule(s) between the A-CSI triggers in the DCI and the corresponding RRH groups are also possible, and may be known to the UE a prior.

Alternatively, the UE could be explicitly configured/indicated by the network the mapping relationship(s)/association rule(s) between the A-CSI triggers in the DCI and the corresponding RRH groups. For instance, the UE could be higher layer configured by the network a RRH group ID list containing multiple RRH group IDs/RRH group-specific higher layer signaling indices. In this example, the first A-CSI trigger in the set of A-CSI triggers in the DCI could correspond to the first entry (and therefore, the corresponding RRH group ID/RRH group-specific higher layer signaling index) in the RRH group ID list, the second A-CSI trigger in the set of A-CSI triggers in the DCI could correspond to the second entry (and therefore, the corresponding RRH group ID/RRH group-specific higher layer signaling index) in the RRH group ID list, and so on, and the last A-CSI trigger in the set of A-CSI triggers in the DCI could correspond to the last entry (and therefore, the corresponding RRH group ID/RRH group-specific higher layer signaling index) in the RRH group ID list.

Other methods of explicitly indicating to the UE the mapping relationship(s)/association rule(s) between the A-CSI triggers in the DCI and the corresponding RRH groups are also possible.

The UE could receive from the network multiple DCIs, each containing a separate A-CSI trigger. Each DCI (and the corresponding CORESET(s)) is associated with a RRH group ID or a RRH group-specific higher layer signaling index. Upon receiving the DCI containing an A-CSI trigger, the UE would know the target RRH group from the associated RRH group ID or RRH group-specific higher layer signaling index.

For the case wherein a single A-CSI trigger state is associated with multiple (Lg) RRH groups, a RRH group could be regarded as a RRH in the design configurations (Configuration-1A, Configuration-1B, Configuration-2A, Configuration-2B, Configuration-3A, and Configuration-3B) discussed above. That is, the definition of the A-CSI trigger state and how it is associated with various CSI resource/report settings/configurations for the Lg RRH groups in the RRH cluster follow those described in Configuration-1A, Configuration-1B, Configuration-2A, Configuration-2B, Configuration-3A, and/or Configuration-3B by regarding a RRH group as a RRH in these design options.

In one example, an A-CSI trigger state is associated with one or more CSI-RS resources in one CSI resource set and one CSI report setting, which are also associated with the Lg RRH groups in the RRH cluster configured for the UE.

In another example, an A-CSI trigger state is associated with one or more CSI-RS resources in one CSI resource set and multiple (more than one) CSI report settings, which are also associated with the Lg RRH groups in the RRH cluster configured for the UE.

In another example, an A-CSI trigger state is associated with multiple (more than one) CSI resource sets in one CSI resource setting and one CSI report setting, which are also associated with the Lg RRH groups in the RRH cluster configured for the UE.

In another example, an A-CSI trigger state is associated with multiple (more than one) CSI resource sets in one CSI resource setting and multiple (more than one) CSI report settings, which are also associated with the Lg RRH groups in the RRH cluster configured for the UE.

In another example, an A-CSI trigger state is associated with multiple (more than one) CSI resource settings and one CSI report setting, which are also associated with the Lg RRH groups in the RRH cluster configured for the UE.

In another example, an A-CSI trigger state is associated with multiple (more than one) CSI resource settings and multiple (more than one) CSI report settings, which are also associated with the Lg RRH groups in the RRH cluster configured for the UE.

For the case wherein a single A-CSI trigger state is associated with a single RRH group in the RRH cluster configured for the UE, the association between the A-CSI trigger state and the RRHs in the RRH group could follow those discussed in Configuration-1A, Configuration-1B, Configuration-2A, Configuration-2B, Configuration-3A, and/or Configuration-3B.

In one example, an A-CSI trigger state is associated with one or more CSI-RS resources in one CSI resource set and one CSI report setting, which are also associated with the RRHs in the RRH group.

In another example, an A-CSI trigger state is associated with one or more CSI-RS resources in one CSI resource set and multiple (more than one) CSI report settings, which are also associated with the RRHs in the RRH group.

In another example, an A-CSI trigger state is associated with multiple (more than one) CSI resource sets in one CSI resource setting and one CSI report setting, which are also associated with the RRHs in the RRH group.

In another example, an A-CSI trigger state is associated with multiple (more than one) CSI resource sets in one CSI resource setting and multiple (more than one) CSI report settings, which are also associated with the RRHs in the RRH group.

In another example, an A-CSI trigger state is associated with multiple (more than one) CSI resource settings and one CSI report setting, which are also associated with the RRHs in the RRH group.

In another example, an A-CSI trigger state is associated with multiple (more than one) CSI resource settings and multiple (more than one) CSI report settings, which are also associated with the RRHs in the RRH group.

In the following description, an RRH can represent a collection of measurement antenna ports or measurement RS resources. For example, an RRH can be associated with a plurality of CSI-RS resources or CRIs (CSI-RS resource indices/indicators). Optionally, an RRH can be associated with a measurement RS resource set—or, for example, CSI resource set along with its indicator.

The term “RRH group” can represent a cluster of RRHs and, hence, a group of collections of measurement RS resources or a group of measurement RS resource sets.

The UE could report in a single reporting instances Kr≥1 CSIs for Kr RRHs/RRH groups in the RRH cluster configured for the UE (a CSI reporting group). The value of Kr could be dynamically indicated to the UE by the network or determined by the UE.

The UE could indicate to the network the association between multiple CSI reporting groups (multiple reporting instances). For instance, the UE could incorporate a reporting ID into the group CSI report. Different CSI reporting groups with the same reporting ID value are associated. Upon receiving the group CSI reports and the associated reporting IDs, the network could know which CSI reporting groups, and therefore the corresponding RRHs/RRH groups, are associated.

The UE could autonomously determine which CSI reporting groups, and therefore the corresponding RRHs/RRH groups, are associated according to a first metric. The UE could be indicated/configured by the network the first metric. Alternatively, the UE could autonomously determine the first metric, and indicate to the network the determined first metric.

The UE could be indicated/configured by the network which RRHs/RRH groups the associated CSIs may be reported in a single reporting instance according to a second metric. Alternatively, the UE could autonomously determine which RRHs/RRH groups the associated CSIs may be reported in a single reporting instance according to the second metric, and indicate to the network the information of the selected RRHs/RRH groups (e.g., as part of the group CSI report). The UE could be indicated/configured by the network the second metric. Alternatively, the UE could autonomously determine the second metric, and indicate to the network the determined second metric. The first metric and the second metric could be different.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a channel state information (CSI) request for one or more entity identities (IDs); and
receive configuration information for an aperiodic CSI (A-CSI) trigger state; and
a processor operably coupled to the transceiver, the processor configured to:
determine, based on the CSI request, the A-CSI trigger state;
determine, based on the determined A-CSI trigger state and the configuration information, one or more CSI resources associated with the one or more entity IDs; and
generate one or more CSI reports based on the determined one or more CSI resources associated with the one or more entity IDs,
wherein the one or more entity IDs correspond to at least one of: a physical cell ID (PCI), a CORESETPoolIndex value, a PCI index pointing to a PCI in a list of PCIs that are higher layer configured to the UE, a reference signal (RS) resource ID, a RS resource set ID, and a RS resource setting ID.

2. The UE of claim 1, wherein:
the configuration information for the A-CSI trigger state indicates a CSI reporting setting provided by a higher layer parameter CSI-ReportConfig,
the CSI reporting setting is linked to one or more CSI resource settings each provided by a higher layer parameter CSI-ResourceConfig, and
each of the one or more CSI resource settings is associated with an entity ID.

3. The UE of claim 1, wherein:
the configuration information for the A-CSI trigger state indicates a CSI reporting setting provided by a higher layer parameter CSI-ReportConfig,
the CSI reporting setting is linked to one or more CSI resource sets each corresponding to at least one of:
a synchronization signal block (SSB) resource set provided by a higher layer parameter CSI-SSB-ResourceSet; and
a non-zero-power (NZP) CSI reference signal (CSI-RS) resource set provided by a higher layer parameter nzp-CSI-RS-ResourceSet, and
each of the one or more CSI resource sets is associated with an entity ID.

4. The UE of claim 1, wherein:
the configuration information for the A-CSI trigger state indicates a CSI reporting setting provided by a higher layer parameter CSI-ReportConfig,
the CSI reporting setting is linked to one or more CSI resources each corresponding to at least one of a synchronization signal block (SSB) resource and a non-zero-power (NZP) CSI reference signal (CSI-RS) resource, and
the one or more CSI resources are configured in a CSI resource set, and each of the one or more CSI resources is associated with an entity ID of the one or more entity IDs.

5. The UE of claim 1, wherein:
the configuration information for the A-CSI trigger state indicates a CSI reporting setting provided by a higher layer parameter CSI-ReportConfig,
the CSI reporting setting is linked to one or more CSI-RS ports of a non-zero-power (NZP) CSI reference signal (CSI-RS) resource, and
each of the one or more CSI-RS ports is associated with an entity ID of the one or more entity IDs.

6. The UE of claim 1, wherein the processor is further configured to:
measure, based on the one or more CSI resources, one or more RSs associated with the one or more entity IDs; and
generate, based on the measured one or more RSs, the one or more CSI reports for the one or more entity IDs.

7. The UE of claim 6, wherein:
the transceiver is further configured to:
transmit the one or more CSI reports in a single CSI reporting instance or separate CSI reporting instances; and
transmit a reporting ID associated with one or more of the CSI reports, and
a CSI report in a CSI reporting instance is associated with another CSI report in a different CSI reporting instance if the CSI report and the other CSI report are associated with a same reporting ID.

8. A base station (BS), comprising:
a processor; and
a transceiver operably coupled to the processor, the transceiver configured to:
transmit a channel state information (CSI) request for one or more entity identities (IDs);
transmit configuration information for an aperiodic CSI (A-CSI) trigger state; and
receive one or more CSI reports based on or more CSI resources associated with the one or more entity IDs,
wherein the one or more CSI resources associated with the one or more entity IDs are indicated based on the A-CSI trigger state and the configuration information, and
wherein the one or more entity IDs correspond to at least one of: a physical cell ID (PCI), a CORESETPoolIndex value, a PCI index pointing to a PCI in a list of PCIs that are higher layer configured, a reference signal (RS) resource ID, a RS resource set ID, and a RS resource setting ID.

9. The BS of claim 8, wherein:
the configuration information for the A-CSI trigger state indicates a CSI reporting setting provided by a higher layer parameter CSI-ReportConfig,
the CSI reporting setting is linked to one or more CSI resource settings each provided by a higher layer parameter CSI-ResourceConfig, and
each of the one or more CSI resource settings is associated with an entity ID.

10. The BS of claim 8, wherein:
the configuration information for the A-CSI trigger state indicates a CSI reporting setting provided by a higher layer parameter CSI-ReportConfig,
the CSI reporting setting is linked to one or more CSI resource sets each corresponding to at least one of:
a synchronization signal block (SSB) resource set provided by a higher layer parameter CSI-SSB-ResourceSet; and
a non-zero-power (NZP) CSI reference signal (CSI-RS) resource set provided by a higher layer parameter nzp-CSI-RS-ResourceSet, and
each of the one or more CSI resource sets is associated with an entity ID.

11. The BS of claim 8, wherein:
the configuration information for the A-CSI trigger state indicates a CSI reporting setting provided by a higher layer parameter CSI-ReportConfig,
the CSI reporting setting is linked to one or more CSI resources each corresponding to at least one of a synchronization signal block (SSB) resource and a non-zero-power (NZP) CSI reference signal (CSI-RS) resource, and
the one or more CSI resources are configured in a CSI resource set, and each of the one or more CSI resources is associated with an entity ID of the one or more entity IDs.

12. The BS of claim 8, wherein:
the configuration information for the A-CSI trigger state indicates a CSI reporting setting provided by a higher layer parameter CSI-ReportConfig,
the CSI reporting setting is linked to one or more CSI-RS ports of a non-zero-power (NZP) CSI reference signal (CSI-RS) resource, and
each of the one or more CSI-RS ports is associated with an entity ID of the one or more entity IDs.

13. The BS of claim 8, wherein the one or more CSI reports is based on one or more RSs associated with the one or more entity IDs.

14. The BS of claim 13, wherein:
the transceiver is further configured to:
receive the one or more CSI reports in a single CSI reporting instance or separate CSI reporting instances; and
receive a reporting ID associated with one or more of the CSI reports, and
a CSI report in a CSI reporting instance is associated with another CSI report in a different CSI reporting instance if the CSI report and the other CSI report are associated with a same reporting ID.

15. A method for operating a user equipment (UE), the method comprising:
receiving a channel state information (CSI) request for one or more entity identities (IDs);
receiving configuration information for an aperiodic CSI (A-CSI) trigger state;
determining, based on the CSI request, the A-CSI trigger state;
determining, based on the determined A-CSI trigger state and the configuration information, one or more CSI resources associated with the one or more entity IDs; and
generating one or more CSI reports based on the determined one or more CSI resources associated with the one or more entity IDs,
wherein the one or more entity IDs correspond to at least one of: a physical cell ID (PCI), a CORESETPoolIndex value, a PCI index pointing to a PCI in a list of PCIs that are higher layer configured to the UE, a reference signal (RS) resource ID, a RS resource set ID, and a RS resource setting ID.

16. The method of claim 15, wherein:
the configuration information for the A-CSI trigger state indicates a CSI reporting setting provided by a higher layer parameter CSI-ReportConfig,
the CSI reporting setting is linked to one or more CSI resource settings each provided by a higher layer parameter CSI-ResourceConfig, and
each of the one or more CSI resource settings is associated with an entity ID.

17. The method of claim 15, wherein:
the configuration information for the A-CSI trigger state indicates a CSI reporting setting provided by a higher layer parameter CSI-ReportConfig,
the CSI reporting setting is linked to one or more CSI resource sets each corresponding to at least one of:
a synchronization signal block (SSB) resource set provided by a higher layer parameter CSI-SSB-ResourceSet; and
a non-zero-power (NZP) CSI reference signal (CSI-RS) resource set provided by a higher layer parameter nzp-CSI-RS-ResourceSet, and
each of the one or more CSI resource sets is associated with an entity ID.

18. The method of claim 15, wherein:
the configuration information for the A-CSI trigger state indicates a CSI reporting setting provided by a higher layer parameter CSI-ReportConfig,
the CSI reporting setting is linked to one or more CSI resources each corresponding to at least one of a synchronization signal block (SSB) resource and a non-zero-power (NZP) CSI reference signal (CSI-RS) resource, and
the one or more CSI resources are configured in a CSI resource set, and each of the one or more CSI resources is associated with an entity ID of the one or more entity IDs.

19. The method of claim 15, wherein:
the configuration information for the A-CSI trigger state indicates a CSI reporting setting provided by a higher layer parameter CSI-ReportConfig,
the CSI reporting setting is linked to one or more CSI-RS ports of a non-zero-power (NZP) CSI reference signal (CSI-RS) resource, and
each of the one or more CSI-RS ports is associated with an entity ID of the one or more entity IDs.

20. The method of claim 15, further comprising:
measuring, based on the one or more CSI resources, one or more RSs associated with the one or more entity IDs; and
wherein generating the one or more CSI reports comprises generating, based on the measured one or more RSs, the one or more CSI reports for the one or more entity IDs.
